(19) United States
(12) Patent Application Publication
(10) Pub. No.: US 2026/0032469 A1
(43) Pub. Date: Jan. 29, 2026

(54) COMMUNICATION CONTROL METHOD

(71) Applicant: KYOCERA Corporation, Kyoto (JP)

(72) Inventors: Mitsutaka HATA, Yokohama-shi (JP); Masato FUJISHIRO, Yokohama-shi (JP)

(73) Assignee: KYOCERA Corporation, Kyoto (JP)

(21) Appl. No.: 19/349,932

(22) Filed: Oct. 3, 2025

Related U.S. Application Data
(63) Continuation of application No. PCT/JP2024/014035, filed on Apr. 5, 2024.

(30) Foreign Application Priority Data
Apr. 6, 2023 (JP) 2023-062137

(51) Int. Cl. H04W 24/02; H04W 48/08

(52) U.S. Cl. CPC H04W 24/02; H04W 48/08

(57) ABSTRACT

The present disclosure relates to a communication control method in a mobile communication system. In the communication control method, a model transmission entity transmits, to a model reception entity, life cycle management (LCM) operation disable information indicating whether a life cycle management (LCM)-related operation is disabled for an artificial intelligence (AI)/machine learning (ML) model and/or LCM operation condition information indicating an execution condition for the life cycle management (LCM)-related operation for the AI/ML model. Here, the life cycle management (LCM) related operation is any one of selection of an AI/ML model, activation of the AI/ML model, deactivation of the AI/ML model, switching of the AI/ML model, fallback from the AI/ML model to a non-AI/ML model, update of the AI/ML model, or transfer of the AI/ML model.

### RELATED APPLICATIONS

The present application is a continuation based on PCT Application No. PCT/JP2024/014035, filed on Apr. 5, 2024, which claims the benefit of Japanese Patent Application No. 2023-062137 filed on Apr. 6, 2023. The content of which is incorporated by reference herein in their entirety.

### TECHNICAL FIELD

The present disclosure relates to a communication control method.

### BACKGROUND

In recent years, in the Third Generation Partnership Project (3GPP) (registered trademark; the same applies hereinafter) that is a standardization project for mobile communication systems, applying an artificial intelligence (AI) technology, in particular, a machine learning (ML) technology to wireless communication (air interface) in a mobile communication system has been studied.

### CITATION LIST

### Non-Patent Literature

Non-Patent Document 1: 3GPP Contribution RP-213599, “New SI: Study on Artificial Intelligence (AI)/Machine Learning (ML) for NR Air Interface”

### SUMMARY

In an aspect, a communication control method is a communication control method in a mobile communication system. In the communication control method, a model transmission entity transmits, to a model reception entity, life cycle management (LCM) operation disable information indicating whether a life cycle management (LCM)-related operation is disabled for an artificial intelligence (AI)/machine learning (ML) model and/or LCM operation condition information indicating an execution condition for the life cycle management (LCM)-related operation for the AI/ML model. Here, the operation related to life cycle management (LCM) is any one of selection of an AI/ML model, activation of the AI/ML model, deactivation of the AI/ML model, switching of the AI/ML model, fallback from the AI/ML model to a non-AI/ML model, update of the AI/ML model, or transfer of the AI/ML model.

### BRIEF DESCRIPTION OF THE DRAWINGS

FIG. 1 is a diagram illustrating a configuration example of a mobile communication system according to a first embodiment.

FIG. 2 is a diagram illustrating a configuration example of a user equipment (UE) according to the first embodiment.

FIG. 3 is a diagram illustrating a configuration example of a base station (gNB) according to the first embodiment.

FIG. 4 is a diagram illustrating a configuration example of a protocol stack according to the first embodiment.

FIG. 5 is a diagram illustrating a configuration example of a protocol stack according to the first embodiment.

FIG. 6 is a diagram illustrating a configuration example of functional blocks of an AI/ML technology according to the first embodiment.

FIG. 7 is a diagram illustrating an operation example in an AI/ML technology according to the first embodiment.

FIG. 8 is a diagram illustrating an arrangement example of functional blocks of the AI/ML technology according to the first embodiment.

FIG. 9 is a diagram illustrating an example of reducing CSI-RSs according to the first embodiment.

FIG. 10 is a diagram illustrating an example of reducing the CSI-RSs according to the first embodiment.

FIG. 11 is a diagram illustrating an operation example according to the first embodiment.

FIG. 12 is a diagram illustrating an arrangement example of functional blocks of the AI/ML technology according to the first embodiment.

FIG. 13 is a diagram illustrating an arrangement example of functional blocks of the AI/ML technology according to the first embodiment.

FIG. 14 is a diagram illustrating an arrangement example of functional blocks of the AI/ML technology according to the first embodiment.

FIG. 15 is a diagram illustrating an operation example according to the first embodiment.

FIG. 16 is a diagram illustrating an arrangement example of functional blocks of the AI/ML technology according to the first embodiment.

FIG. 17 is a diagram illustrating an operation example according to the first embodiment.

FIG. 18 is a diagram illustrating an operation example according to the first embodiment.

FIG. 19 is a diagram illustrating an example of a configuration message according to the first embodiment.

FIG. 20 is a diagram illustrating a configuration example of a mobile communication system according to the first embodiment.

FIG. 21 is a diagram illustrating an operation example according to the first embodiment.

FIGS. 22A and 22B are diagrams illustrating configuration examples of a mobile communication system according to a second embodiment.

FIG. 23 is a diagram illustrating a configuration example of the mobile communication system according to the second embodiment.

FIG. 24 is a diagram illustrating an operation example according to the second embodiment.

FIG. 25 is a diagram illustrating an operation example according to a third embodiment.

FIG. 26 is a diagram illustrating an example of a relationship between a model and model data according to a fourth embodiment.

FIG. 27 is a diagram illustrating an operation example according to the fourth embodiment.

### DESCRIPTION OF EMBODIMENTS

An object of the present disclosure is to enable a user equipment to appropriately execute an operation related to life cycle management on an AI/ML model.

### First Embodiment

A mobile communication system according to a first embodiment will be described with reference to the drawings. In the description of the drawings, the same or similar parts are denoted by the same or similar reference signs.

### Configuration of Mobile Communication System

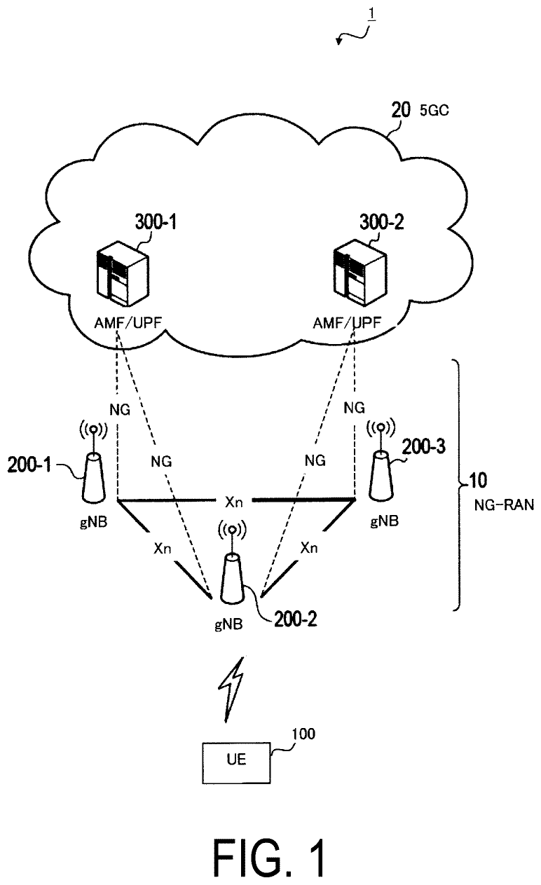

A configuration of a mobile communication system according to a first embodiment will be described. FIG. 1 is a diagram illustrating a configuration example of the mobile communication system 1 according to the first embodiment. The mobile communication system 1 complies with the 5th Generation System (5GS) of the 3GPP standard. 5GS will be hereinafter used as an example, but a Long Term Evolution (LTE) system may be applied at least partially to the mobile communication system. A system of the sixth (6G) or subsequent generation system may be at least partially applied to the mobile communication system.

The mobile communication system 1 includes a User Equipment (UE) 100, a 5G radio access network (Next Generation Radio Access Network (NG-RAN)) 10, and a 5G Core Network (5GC) 20. The NG-RAN 10 will be hereinafter simply referred to as the RAN 10. The 5GC 20 may be simply referred to as the core network (CN) 20.

The UE 100 is a mobile wireless communication apparatus. The UE 100 may be any apparatus as long as the UE 100 is used by a user. Examples of the UE 100 include a mobile phone terminal (including a smartphone) and/or a tablet terminal, a notebook PC, a communication module (including a communication card or a chipset), a sensor or an apparatus provided on a sensor, a vehicle or an apparatus provided on a vehicle (Vehicle UE), and a flying object or an apparatus provided on a flying object (Aerial UE).

The NG-RAN 10 includes base stations (referred to as “gNBs” in the 5G system) 200. The gNBs 200 are interconnected via an Xn interface which is an inter-base station interface. Each gNB 200 manages one or more cells. The gNB 200 performs wireless communication with the UE 100 that has established a connection to the cell of the gNB 200. The gNB 200 has a radio resource management (RRM) function, a function of routing user data (hereinafter simply referred to as “data”), a measurement control function for mobility control and scheduling, and the like. The “cell” is used as a term representing a minimum unit of a wireless communication area. The “cell” is also used as a term representing a function or a resource for performing wireless communication with the UE 100. One cell belongs to one carrier frequency (hereinafter simply referred to as a “frequency”).

Note that the gNB can be connected to an Evolved Packet Core (EPC) corresponding to a core network of LTE. An LTE base station can also be connected to the 5GC. The LTE base station and the gNB can be connected via an inter-base station interface.

The 5GC 20 includes an Access and Mobility Management Function (AMF) and a User Planc Function (UPF) 300. The AMF performs various types of mobility controls and the like for the UE 100. The AMF manages mobility of the UE 100 by communicating with the UE 100 by using Non-Access Stratum (NAS) signaling. The UPF controls data transfer. The AMF and UPF 300 are connected to the gNB 200 via an NG interface which is an interface between a base station and the core network. The AMF and the UPF 300 may be core network apparatuses included in the CN 20.

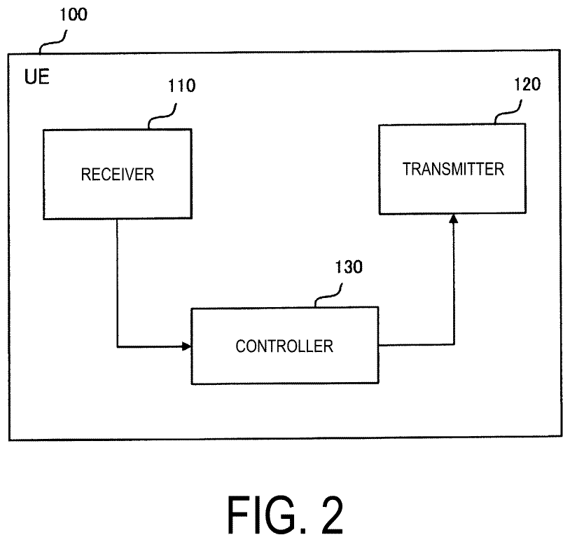

FIG. 2 is a diagram illustrating a configuration example of the UE 100 (user equipment) according to the first embodiment. The UE 100 includes a receiver 110, a transmitter 120, and a controller 130. The receiver 110 and the transmitter 120 constitute a communicator that performs wireless communication with the gNB 200. The UE 100 is an example of the communication apparatus.

The receiver 110 performs various receptions under the control of the controller 130. The receiver 110 includes an antenna and a reception device. The reception device converts a radio signal or a terahertz wave signal received through the antenna into a baseband signal (a reception signal) and outputs the resulting signal to the controller 130.

The transmitter 120 performs various transmissions under the control of the controller 130. The transmitter 120 includes an antenna and a transmission device. The transmission device converts a baseband signal (a transmission signal) output by the controller 130 into a radio signal or a terahertz wave signal and transmits the resulting signal through the antenna.

The controller 130 performs various controls and processes in the UE 100. Such processing includes processing of respective layers to be described later. The controller 130 includes at least one processor and at least one memory. The memory stores a program to be executed by the processor and information to be used for processing in the processor. The processor may include a baseband processor and a Central Processing Unit (CPU). The baseband processor performs modulation and demodulation, coding and decoding, and the like of a baseband signal. The CPU executes the program stored in the memory to thereby perform various types of processing. Note that processing or operations performed in the UE 100 may be performed in the controller 130.

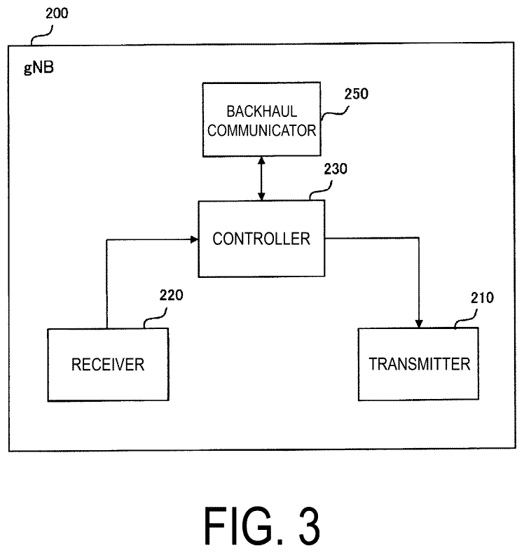

FIG. 3 is a diagram illustrating an example of a configuration of the gNB 200 (base station) according to the first embodiment. The gNB 200 includes a transmitter 210, a receiver 220, a controller 230, and a backhaul communicator 250. The transmitter 210 and the receiver 220 constitute a communicator that performs wireless communication with the UE 100. The backhaul communicator 250 constitutes a network communicator that communicates with the CN 20. The gNB 200 is another example of the communication apparatus.

The transmitter 210 performs various transmissions under the control of the controller 230. The transmitter 210 includes an antenna and a transmission device. The transmission device converts a baseband signal (a transmission signal) output by the controller 230 into a radio signal or a terahertz wave signal and transmits the resulting signal through the antenna.

The receiver 220 performs various types of reception under control of the controller 230. The receiver 220 includes an antenna and a reception device. The reception device converts a radio signal or a terahertz wave signal received through the antenna into a baseband signal (a reception signal) and outputs the resulting signal to the controller 230.

The controller 230 performs various types of control and processing in the gNB 200. Such processing includes processing of respective layers to be described later. The controller 230 includes at least one processor and at least one memory. The memory stores a program to be executed by the processor and information to be used for processing in the processor. The processor may include a baseband processor and a CPU. The baseband processor performs modulation and demodulation, coding and decoding, and the like of a baseband signal. The CPU executes the program stored in the memory to thereby perform various types of processing. In an example described below, operations or processing performed in the gNB 200 may be performed by the controller 230.

The backhaul communicator 250 is connected to a neighboring base station via an Xn interface which is an inter-base station interface. The backhaul communicator 250 is connected to the AMF/UPF 300 via an NG interface being an interface between a base station and the core network. Note that the gNB 200 may include a central unit (CU) and a distributed unit (DU) (i.e., functions are divided), and the two units may be connected via an F1 interface, which is a fronthaul interface.

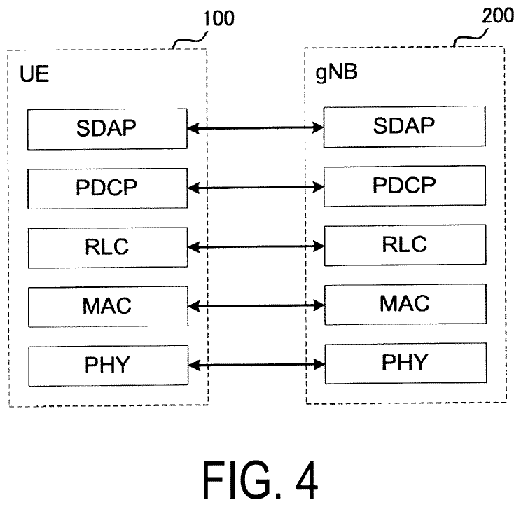

FIG. 4 is a diagram illustrating an example of a configuration of a protocol stack of a user plane radio interface that handles data.

The user plane radio interface protocol includes a physical (PHY) layer, a medium access control (MAC) layer, a radio link control (RLC) layer, a packet data convergence protocol (PDCP) layer, and a service data adaptation protocol (SDAP) layer.

The PHY layer performs encoding/decoding, modulation/demodulation, antenna mapping/demapping, and resource mapping/demapping. Data and control information are transmitted between the PHY layer of the UE 100 and the PHY layer of the gNB 200 via a physical channel. Note that the PHY layer of the UE 100 receives downlink control information (DCI) transmitted from the gNB 200 over a physical downlink control channel (PDCCH). Specifically, the UE 100 performs blind decoding of the PDCCH by using a radio network temporary identifier (RNTI) and acquires a successfully decoded DCI as a DCI addressed to the UE. Cyclic redundancy code (CRC) parity bits scrambled by the RNTI are added to the DCI transmitted from the gNB 200.

In NR, the UE 100 can use a bandwidth narrower than a system bandwidth (i.e., a cell bandwidth). The gNB 200 configures a bandwidth part (BWP) consisting of consecutive Physical Resource Blocks (PRBs) for the UE 100. The UE 100 transmits and receives data and control signals in an active BWP. For example, up to four BWPs may be configurable for the UE 100. Each BWP may have a different subcarrier spacing. Frequencies of the BWPs may overlap with each other. When a plurality of BWPs are configured for the UE 100, the gNB 200 can designate which BWP to apply by controlling the downlink. By doing so, the gNB 200 dynamically adjusts the UE bandwidth according to an amount of data traffic in the UE 100 or the like to reduce the UE power consumption.

The gNB 200 can configure, for example, up to three control resource sets (CORESETs) for each of up to four BWPs on a serving cell. The CORESET is a radio resource for control information to be received by the UE 100. Up to 12 or more CORESETs may be configured for the UE 100 on the serving cell. Each CORESET may have an index of 0 to 11 or more. A CORESET may include 6 resource blocks (PRBs) and one, two or three consecutive Orthogonal Frequency Division Multiplex (OFDM) symbols in the time domain.

The MAC layer performs priority control of data, retransmission processing through hybrid ARQ (HARQ: Hybrid Automatic Repeat reQuest), a random access procedure, and the like. Data and control information are transmitted between the MAC layer of the UE 100 and the MAC layer of the gNB 200 via a transport channel. The MAC layer of the gNB 200 includes a scheduler. The scheduler decides transport formats (transport block sizes, Modulation and Coding Schemes (MCSs)) in the uplink and the downlink and resource blocks to be allocated to the UE 100.

The RLC layer transmits data to the RLC layer on the receiving side by using functions of the MAC layer and the PHY layer. Data and control information are transmitted between the RLC layer of the UE 100 and the RLC layer of the gNB 200 via a logical channel.

The PDCP layer performs header compression/decompression, encryption/decryption, and the like.

The SDAP layer performs mapping between IP flows, which are units for Quality of Service (QoS) control by the core network, and radio bearers, which are units for QoS control by the Access Stratum (AS). Note that, when the RAN is connected to the EPC, the SDAP need not be provided.

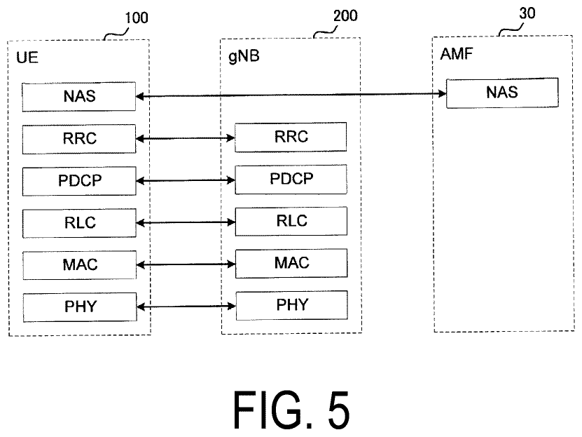

FIG. 5 is a diagram illustrating a configuration of a protocol stack of a radio interface of a control plane handling signaling (a control signal).

The protocol stack of the radio interface of the control plane includes a radio resource control (RRC) layer and a Non-Access Stratum (NAS) instead of the SDAP layer illustrated in FIG. 4.

RRC signaling for various configurations is transmitted between the RRC layer of the UE 100 and the RRC layer of the gNB 200. The RRC layer controls a logical channel, a transport channel, and a physical channel according to establishment, re-establishment, and release of a radio bearer. When a connection (RRC connection) between the RRC of the UE 100 and the RRC of the gNB 200 is present, the UE 100 is in an RRC connected state. When no connection (RRC connection) between the RRC of the UE 100 and the RRC of the gNB 200 is present, the UE 100 is in an RRC idle state. When the connection between the RRC of the UE 100 and the RRC of the gNB 200 is suspended, the UE 100 is in an RRC inactive state.

The NAS, which is located above the RRC layer, performs session management, mobility management, and the like. NAS signaling is transmitted between the NAS of the UE 100 and the NAS of the AMF 300. The UE 100 includes an application layer and the like other than the protocol of the radio interface. Further, a layer lower than the NAS is referred to as an access stratum (AS).

### AI/ML Technology

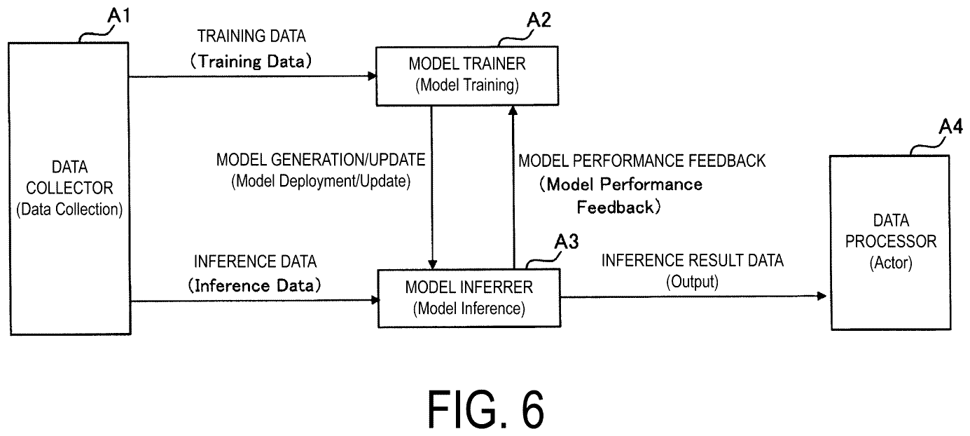

In the embodiment, an AI/ML Technology will be described. FIG. 6 is a diagram illustrating a configuration example of functional blocks of the AI/ML technology in the mobile communication system 1 according to the first embodiment.

The functional block configuration example illustrated in FIG. 6 includes a data collector A1, a model trainer A2, a model inferrer A3, and a data processor A4.

The data collector A1 collects input data, specifically, training data and inference data. The data collector A1 outputs the training data to the model trainer A2. The data collector A1 also outputs the inference data to the model inferrer A3. The data collector A1 may acquire data in the apparatus in which the data collector A1 is provided, as input data. The data collector A1 may acquire, as the input data, data in another apparatus. Data collection refers to a process of collecting data at a network node, a management entity, or the UE 100, for example, in order to perform training, data analysis, and inference of the AI/ML model. Based on the data collected by the data collector A1, the training of the AI/ML model and the inference of the AI/ML model in the subsequent stage are performed. The “AI/ML model” is, for example, a data-driven algorithm to which an AI/ML technology is applied to generate a series of outputs based on a series of inputs. Hereinafter, “model” and “AI/ML model” may be used interchangeably.

The model trainer A2 performs model training. Specifically, the model trainer A2 optimizes parameters of the training model through machine learning using the training data, and derives (or generates, or updates) the trained model. The model trainer A2 outputs the derived trained model to the model inferrer A3. For example, considering y=ax+b, a (slope) and b (intercept) are the parameters, and optimizing these parameters corresponds to the machine learning. In general, machine learning includes supervised learning, unsupervised learning, and reinforcement learning. Supervised learning is a method of using correct answer data for the training data. Unsupervised learning is a method of not using correct answer data for the training data. For example, in unsupervised learning, feature points are learned from a large amount of training data, and correct answer determination (range estimation) is performed. The reinforcement learning is a method of assigning a score to an output result and learning a method of maximizing the score. Although the supervised learning will be described hereinafter, unsupervised learning may be applied as the machine learning. As the machine learning, reinforcement learning may be applied. Thus, a process of training the AI/ML model (by learning a relationship between the input and the output) in a data driven manner to acquire a trained AI/ML model is referred to as, for example, AI/ML model training. Hereinafter, the “AI/ML model training” may be referred to as a “model training”.

The model inferrer A3 performs model inference. To be specific, the model inferrer A3 infers an output from the inference data by using the trained model, and outputs inference result data to the data processor A4. For example, considering y=ax+b, x is the inference data and y corresponds to the inference result data. Note that “y=ax+b” is a model. A model in which a slope and an intercept are optimized, for example, “y=5x+3” is a trained model. The model has various approaches, such as linear regression analysis, neural network, and decision tree analysis. The above “y=ax+b” can be considered as a kind of the linear regression analysis. The model inferrer A3 may perform model performance feedback to the model trainer A2. The process of generating a series of outputs based on a series of inputs using the trained AI/ML model in this manner is referred to as AI/ML model inference. Hereinafter, the “AI/ML model inference” may be referred to as “model inference”.

The data processor A4 receives the inference result data and performs processing that utilizes the inference result data.

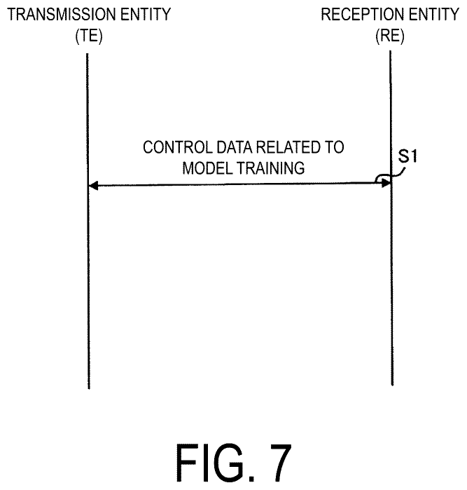

FIG. 7 is a diagram illustrating an operation example in the AI/ML technology according to the first embodiment.

A transmission entity TE is, for example, an entity in which machine learning is performed. The transmission entity TE derives a trained model by performing machine learning. Then, the transmission entity TE uses the trained model to generate inference result data as an inference result. The transmission entity TE transmits the inference result data to a reception entity RE.

The reception entity RE is, for example, an entity in which no machine learning is performed. The transmission entity TE performs various processing operations by using the inference result data received from the transmission entity TE.

Note that the entity may be, for example, a device. The entity may be a functional block included in the device. The entity may be, for example, a hardware block included in the device.

For example, the transmission entity TE may be the UE 100, and the reception entity RE may be the gNB 200 or a core network apparatus. Alternatively, the transmission entity TE may be the gNB 200 or a core network apparatus, and the reception entity RE may be the UE

As illustrated in FIG. 7, in a step S1, the transmission entity TE transmits to and receives from the reception entity RE control data related to the AI/ML technology. The control data may be an RRC message that is RRC layer (i.e., layer 3) signaling. The control data may be a MAC Control Element (CE) that is MAC layer (i.e., layer 2) signaling. The control data may be Downlink Control Information (DCI) that is PHY layer (i.e., layer 1) signaling. The downlink signaling may be UE-specific signaling. The downlink signaling may be broadcast signaling. The control data may be a control message in a control layer (for example, an AI/ML layer) dedicated to artificial intelligence or machine learning.

### Arrangement Examples and Use Cases

How the functional blocks illustrated in FIG. 6 are arranged in the mobile communication system 1 will be described. Hereinafter, arrangement examples of the functional blocks will be described along specific use cases.

Use cases applied in the AI/ML technology include, for example, the following three cases.
(1.1) “Channel State Information (CSI) feedback enhancement”
(1.2) “Beam management”
(1.3) “Positioning accuracy enhancement”

Hereinafter, an arrangement example of the functional blocks will be described for each use case.

(1.1) Arrangement Example of Functional Blocks in “CSI Feedback Enhancement” The “CSI feedback enhancement” represents, for example, a use case in which the machine learning technology is applied to the CSI fed back from the UE 100 to the gNB 200. The CSI is information related to a downlink channel state between the UE 100 and the gNB 200. The CSI includes at least one selected from the group consisting of a Channel Quality Indicator (CQI), a Precoding Matrix Indicator (PMI), and a Rank Indicator (RI). The gNB 200 performs, for example, downlink scheduling based on the CSI feedback from the UE 100.

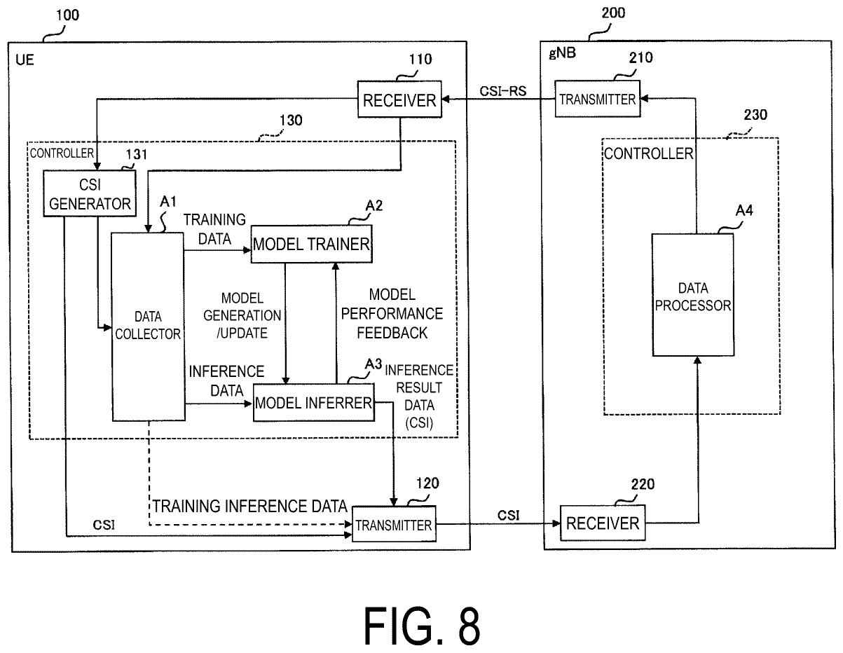

FIG. 8 is a diagram illustrating an arrangement example of the functional blocks in the “CSI feedback enhancement”. In the example of “CSI feedback enhancement” illustrated in FIG. 8, the controller 130 of the UE 100 includes the data collector A1, the model trainer A2, and the model inferrer A3. On the other hand, the controller 230 of the gNB 200 includes the data processor A4. In other words, the UE 100 performs model training and model inference. FIG. 8 illustrates an example in which the transmission entity TE is the UE 100 and the reception entity RE is the gNB 200.

In the “CSI feedback enhancement”, the gNB 200 transmits a reference signal for the UE 100 to estimate the downlink channel state. The reference signal will be described below taking a CSI reference signal (CSI-RS) as an example, but may be a demodulation reference signal (DMRS).

First, in the model training, the UE 100 (receiver 110) receives a first reference signal from the gNB 200 by using first resources. Then, the UE 100 (model trainer A2) derives a trained model for inferring CSI from the reference signal by using training data including the first reference signal. Such a first reference signal may be referred to as a full CSI-RS.

For example, the CSI generator 131 performs channel estimation by using the reception signal (CSI-RS) received by the receiver 110, and generates CSI. The transmitter 120 transmits the generated CSI to the gNB 200. The model trainer A2 performs model training by using a set of the reception signal (CSI-RS) and the CSI as the training data to derive a trained model for inferring the CSI from the reception signal (CSI-RS).

Second, in the model inference, the receiver 110 receives a second reference signal from the gNB 200 by using second resources the amount of which is smaller than that of the first resources. Then, the model inferrer A3 uses the trained model to infer the CSI as inference result data using the second reference signal as inference data. Such a second reference signal may hereinafter be referred to as a partial CSI-RS or a punctured CSI-RS.

For example, the model inferrer A3 causes the partial CSI-RS received by the receiver 110 to be input to the trained model as the inference data, and infers the CSI from the CSI-RS. The transmitter 120 transmits the inferred CSI to the gNB 200.

This enables the UE 100 to feed back (or transmit), to the gNB 200, accurate (complete) CSI from the fewer CSI-RSs (partial CSI-RS) received from the gNB 200. For example, the gNB 200 can reduce (puncture) the CSI-RS when intended for overhead reduction. The UE 100 can cope with a situation in which a radio situation deteriorates and some CSI-RSs cannot be normally received.

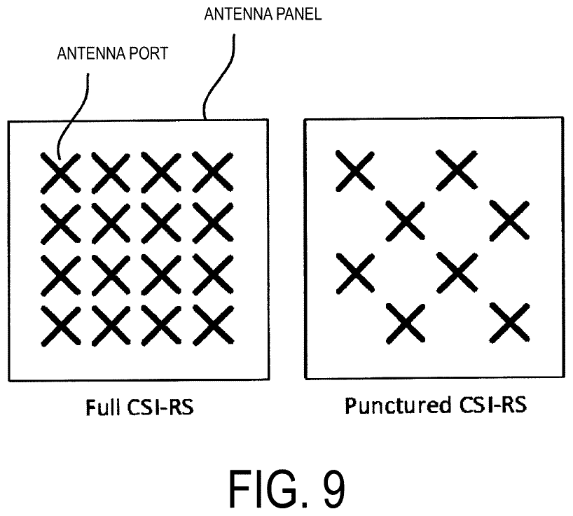

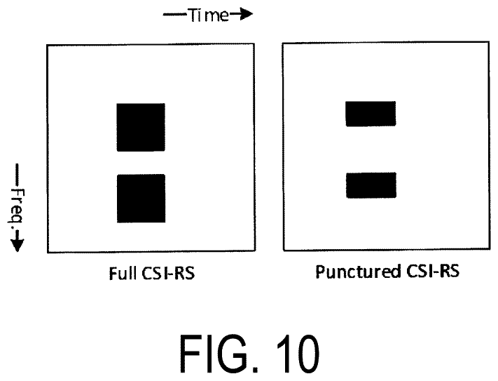

FIGS. 9 and 10 are diagrams illustrating an example of reducing CSI-RSs according to the first embodiment.

FIG. 9 illustrates an example in which the CSI-RSs are reduced by reducing the number of antenna ports for transmitting the CSI-RSs. For example, the gNB 200 may perform the following processing. In other words, the gNB 200 transmits the CSI-RS from all antenna ports of the antenna panel in a mode in which the UE 100 performs the model training (which may hereinafter be referred to as a “training mode”). On the other hand, in the mode in which the UE 100 performs model inference (which may hereinafter be referred to as an “inference mode”), the gNB 200 reduces the number of antenna ports for transmitting the CSI-RS, and transmits the CSI-RS from half the antenna ports of the antenna panel. This enables reduced overhead and improved utilization efficiency for the antenna ports, and allows a reduction effect for power consumption to be produced. Note that the antenna port is an example of the resource.

On the other hand, FIG. 10 illustrates an example in which the gNB 200 reduces the number of radio resources used to transmit the CSI-RS, specifically, the number of time-frequency resources. For example, the gNB 200 may perform the following processing. In other words, when the UE 100 is in the training mode, the gNB 200 transmits the CSI-RS by using predetermined time-frequency resources. On the other hand, when the UE 100 is in the inference mode, the gNB 200 transmits the CSI-RS using time-frequency resources the amount of which is smaller than that of the predetermined time-frequency resources. This enables reduced overhead and improved utilization efficiency for the radio resources, and allows a reduction effect for power consumption to be produced.

As illustrated in FIGS. 9 and 10, the gNB 200 transmits the full CSI-RS using a predetermined amount of first resources, and transmits the partial CSI-RS using second resources that are less than the first resources.

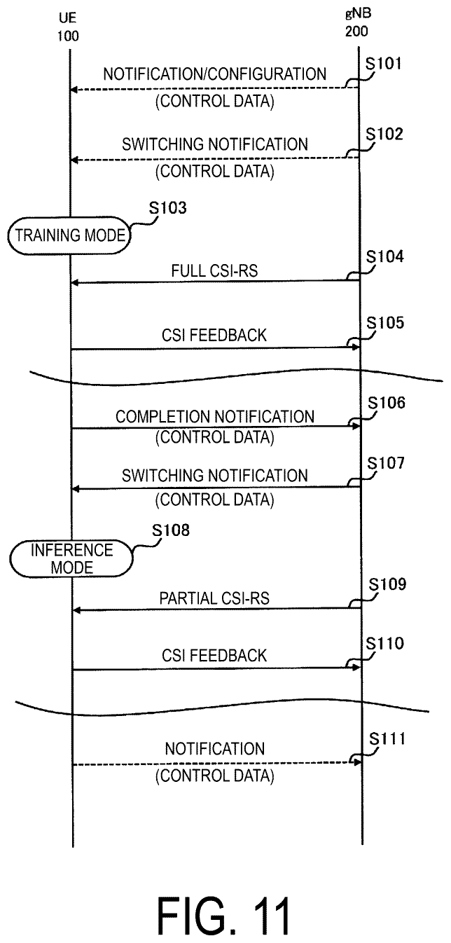

FIG. 11 illustrates an operation example in the “CSI feedback enhancement” according to the first embodiment.

As illustrated in FIG. 11, in step S101, the gNB 200 may notify the UE 100 of or configure for the UE, as the control data, a transmission pattern (punctured pattern) of the CSI-RS in the inference mode. For example, the gNB 200 transmits, to the UE 100, antenna ports and/or time-frequency resources used or not used to transmit the CSI-RS in the inference mode.

In step S102, the gNB 200 may transmit, to the UE 100, a switching notification for causing the UE 100 to start the training mode.

In step S103, the UE 100 starts the training mode.

In step S104, the gNB 200 transmits a full CSI-RS. The receiver 110 of the UE 100 receives the full CSI-RS, and the CSI generator 131 generates (estimates) CSI based on the full CSI-RS. In the training mode, the data collector A1 collects the full CSI-RS and the CSI. The model trainer A2 uses the full CSI-RS and the CSI as training data to generate a trained model.

In step S105, the UE 100 transmits the generated CSI to the gNB 200.

Thereafter, in step S106, when the model training is completed, the UE 100 transmits, to the gNB 200, a completion notification indicating that the model training is completed. The UE 100 may transmit the completion notification when creation of the trained model is completed.

In step S107, in response to receiving the completion notification, the gNB 200 transmits, to the UE 100, a switching information notification for switching the UE 100 from the training mode to the inference mode.

In step S108, in response to receiving the switching notification, the UE 100 switches from the training mode to the inference mode.

In step S109, the gNB 200 transmits a partial CSI-RS. The receiver 110 of the UE 100 receives the partial CSI-RS. In the inference mode, the data collector A1 collects the partial CSI-RS. The model inferrer A3 causes the partial CSI-RS to be input to the trained model as inference data, and obtains CSI as an inference result.

In step S110, the UE 100 transmits (or feeds back) the CSI, which is an inference result, to the gNB 200 as inference result data. The UE 100 can generate a trained model with a predetermined accuracy or higher by repeating model training in the training mode. The inference result obtained by using the trained model generated as described above is expected to have a predetermined accuracy or higher.

Note that, in step S111, upon determining that the model training is necessary, the UE 100 may transmit a notification as the control data to the gNB 200, the notification indicating that the model training is necessary.

In the description of the example illustrated in FIG. 11, the training data is “(full) CSI-RS” and “CSI”, and the inference data is “(partial) CSI-RS”. Hereinafter, the training data and/or the inference data may be referred to as a “dataset”.

In the “CSI feedback enhancement”, for example, at least one selected from the group consisting of the following data or information may be used as the dataset in addition to the “CSI-RS” and the “CSI”.
(X1) Reference Signals Received Power (RSRP), Reference Signal Received Quality (RSRQ), Signal-to-interference-plus-noise ratio (SINR), or an output waveform of an AD converter (a measurement target of these data may be the CSI-RS. The measurement target may be other reception signals received from the gNB 200)
(X2) Bit Error Rate (BER) or Block Error Rate (BLER) ((BER (or BLER) may be measured based on CSI-RS with a total number of transmission bits (or a total number of transmission blocks) being known)
(X3) Moving speed of the UE 100 (which may be measured by a speed sensor in the UE 100)
   What is used as a dataset used for machine learning may be configured. For example, the following processing may be performed. In other words, the UE 100 transmits capability information as the control data to the gNB 200, the capability information indicating which type of input data the UE 100 can handle in the machine learning. The capability information may represent, for example, any of the data or information indicated in (X1) to (X3). The capability information may be information in which training data and inference data are separately designated. The gNB 200 transmits the data type information used as a dataset, to the UE 100 as the control data. The data type information may represent, for example, any one of data or information indicated in (X1) to (X3). As the data type information, data type information used as training data and data type information used as inference data may be separately designated.

(1.2) Arrangement Example of Functional Blocks in “Beam Management” An arrangement example of the functional blocks in the “beam management” will be described. The “beam management” represents, for example, a use case in which the machine learning technology is used to manage which beam is an optimum beam among the beams transmitted from the gNB 200.

In the “beam management”, the gNB 200 sequentially transmits beams having different directivities. Each beam includes, for example, a reference signal. The UE 100 measures the reception quality of each beam using the reference signal included in the beam. The UE 100 determines, for example, a beam with the best reception quality as the optimum beam.

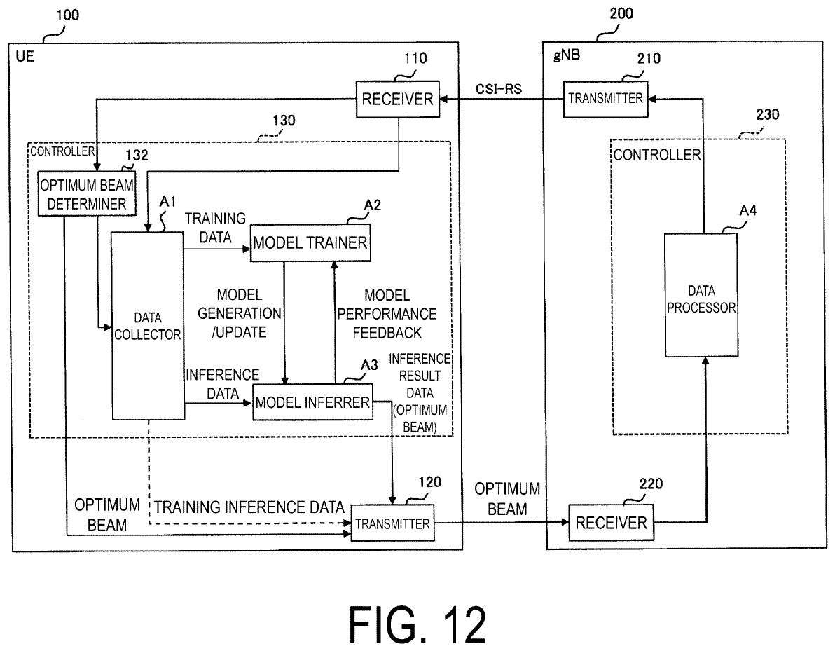

FIG. 12 is a diagram illustrating an arrangement example of the functional blocks in the “beam management”. In the example of the “beam management” illustrated in FIG. 12, the controller 130 of the UE 100 includes the data collector A1, the model trainer A2, and the model inferrer A3. On the other hand, the controller 230 of the gNB 200 includes the data processor A4. In other words, FIG. 12 illustrates an example in which the UE 100 performs model training and model inference. FIG. 12 illustrates the example in which the transmission entity TE is the UE 100 and the reception entity RE is the gNB 200.

As illustrated in FIG. 12, the UE 100 includes an optimum beam determiner 132. The optimum beam determiner 132 determines the optimum beam based on, for example, the reception quality of the reference signal included in each beam. As with “CSI feedback”, an example in which a CSI-RS is used as the reference signal will be described, but a demodulation reference signal (DMRS) may be used as the reference signal. The transmitter 120 transmits information representing the determined optimum beam to the gNB 200 as the “optimum beam”.

An operation example in the “beam management” can be implemented by replacing the “CSI feedback” with the “optimum beam” in FIG. 11.

In the training mode (step S103), the gNB 200 sequentially transmits, to the UE 100, beams having different directivities (step S104). Each beam includes the full CSI-RS. In the training mode, the data collector A1 of the UE 100 collects the full CSI-RS and the optimum beam (information indicating the optimum beam). The model trainer A2 generates a trained model using the CSI-RS and the optimum beam (information indicating the optimum beam) as training data. The full CSI-RS is an example of the first reference signal, and the partial CSI-RS is an example of the second reference signal.

In the inference mode (step S108), the gNB 200 sequentially transmits beams having different directivities. Each beam includes a partial CSI-RS. In the inference mode, the data collector A1 collects the partial CSI-RS. The model inferrer A3 causes the partial CSI-RS to be input to the trained model as inference data, and obtains the optimum beam (information indicating the optimum beam) as an inference result. The UE 100 transmits the inference result (optimum beam) to the gNB 200 as inference result data.

In the “beam management”, in addition to the “CSI-RS” and the “optimum beam”, for example, at least one selected from the group consisting of the following data or information may be used as the data used for the dataset.
(Y1) Synchronization Signal Block (SSB) received from the gNB 200
(Y2) RSRP, RSRQ, SINR, or the output waveform of the AD converter (a measurement target thereof may be the CSI-RS. The measurement target may be other reception signals received from the gNB 200)
(Y3) BER or BLER ((BER (or BLER) may be measured based on the CSI-RS with the total number of transmission bits (or the total number of transmission blocks) known)
(Y4) Number of beams or a beam pattern
(Y5) Measurement value of a beam (including multiple values)
(Y6) Moving speed of the UE 100 (which may be measured by the speed sensor in the UE 100)

The UE 100 may transmit capability information as the control data to the gNB 200, the capability information indicating which type of input data the UE 100 can handle in the machine learning. The capability information may include any information or data from among (Y1) to (Y6). Aside from the training data and the inference data, the capability information may include any information or data from among (Y1) to (Y6). The gNB 200 may transmit the data type information used as a dataset, to the UE 100 as the control data. The data type information may include, for example, any of the data or information indicated in (Y1) to (Y6). Aside from the training data and the inference data, the data type information may include any information or data from among (Y1) to (Y6).

### (1.3) Arrangement Example of Functional Blocks in “Positioning Accuracy Enhancement”

An arrangement example of the functional blocks in the “positioning accuracy enhancement” will be described. The “positioning accuracy enhancement” represents, for example, a use case in which the accuracy of the position information measured by the UE 100 is enhanced using the machine learning technology.

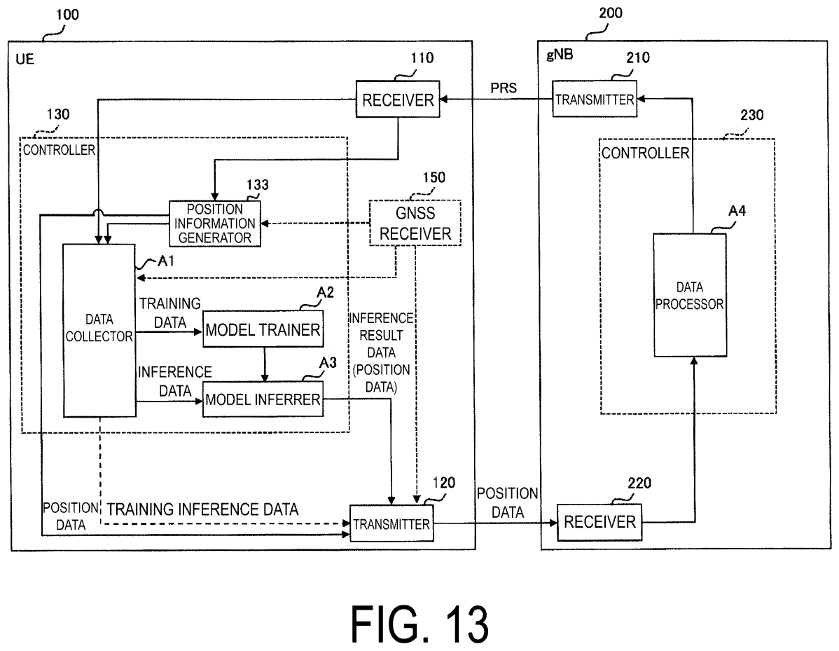

FIG. 13 is a diagram illustrating an arrangement example of the functional blocks in the “positioning accuracy enhancement”. In the example of the “positioning accuracy enhancement” illustrated in FIG. 9, the controller 130 of the UE 100 includes the data collector A1, the model trainer A2, and the model inferrer A3. On the other hand, the controller 230 of the gNB 200 includes the data processor A4. In other words, FIG. 13 illustrates an example in which the UE 100 performs model training and model inference. FIG. 13 illustrates an example in which the transmission entity TE is the UE 100 and the reception entity RE is the gNB 200.

As illustrated in FIG. 13, the UE 100 includes a position information generator 133. The UE 100 may include a Global Navigation Satellite System (GNSS) reception device 150. The position information generator 133 generates position data of the UE 100 based on a Positioning Reference Signal (PRS) received from the gNB 200. The position information generator 133 may receive a GNSS signal (full GNSS signal or partial GNSS signal) received by the GNSS reception device 150 and generate the position data of the UE 100 based on the GNSS signal.

Note that, as is the case with the full CSI-RS, the gNB 200 transmits the full PRS using a predetermined amount of first resources (for example, all antenna ports as illustrated in FIG. 9 or a predetermined amount of time frequency resources as illustrated in FIG. 10). Further, as with the partial CSI-RS, the gNB 200 transmits the partial PRS by using the second resource (for example, half the antenna ports in the antenna panel as illustrated in FIG. 9, or half the predetermined number of time-frequency resources as illustrated in FIG. 10) having the smaller number of resources than the first resources.

Further, the full GNSS signal may be a GNSS signal temporally continuously received by the GNSS reception device 150. The partial GNSS signal may be a GNSS signal intermittently received by the GNSS reception device 150. In other words, a predetermined amount of first resources may be used for the full GNSS signal, and the second resources the amount of which is smaller than that of the first resources may be used for the partial GNSS signal.

An operation example in the “position accuracy improvement” can be implemented by replacing the “full CSI-RS” with the “full PRS”, the “partial CSI-RS” with the “partial PRS”, and the “CSI feedback” with the “position data” in FIG. 11.

In the training mode (step S103), the position information generator 133 generates the position data of the UE 100 based on the full PRS received from the gNB 200. The position information generator 133 may receive a full GNSS signal received by the GNSS reception device 150 and generate the position data of the UE 100 based on the full GNSS signal. The transmitter 120 feeds back (or transmits) the position data to the gNB 200. The data collector A1 collects the full PRS (or the full GNSS signal) and the position data. The model trainer A2 generates a trained model using the full PRS (or the full GNSS signal) and the position data as training data.

In the inference mode (step S108), the data collector A1 collects the partial PRS received by the receiver 110 (or the partial GNSS signal received by the GNSS reception device 150). The model inferrer A3 causes the partial PRS (or the partial GNSS signal) and the position data to be input to the trained model as inference data, and obtains the position data as an inference result. The UE 100 transmits the inference result (position data) to the gNB 200 as inference result data.

In the “positioning accuracy enhancement”, in addition to the “PRS”, the “GNSS signal”, and the “position data”, for example, at least one selected from the group consisting of the following data or information may be used as the data used for the dataset.
(Z1) RSRP, RSRQ, Signal-to-interference-plus-noise ratio (SINR), or the output waveform of the AD converter (a measurement target of these data may be the PRS. The measurement target may be other reception signals received from the gNB 200)
(Z2) Line Of Sight (LOS) or Non Line Of Sight (NLOS)
(Z3) Measurement timing, accuracy, likelihood
(Z4) RF fingerprint (cell ID and reception quality in the cell having the cell ID)
(Z5) Angle of Arrival (AOA) of a reception signal, a reception level for each antenna, a reception phase for each antenna, and an Observed Time Difference Of Arrival (OTDOA) for each antenna
(Z6) Reception information of a beacon used in short-range wireless communication such as wireless local area network (LAN) such as Wi-Fi (registered trademark), or Bluetooth (registered trademark)
(Z7) Moving speed of the UE 100 (the moving speed may be measured by the GNSS reception device 150. The moving speed may be measured by a speed sensor in the UE 100) The UE 100 may transmit capability information as the control data to the gNB 200, the capability information indicating which type of input data the UE 100 can handle in the machine learning. The capability information may include any information or data from among (Z1) to (Z7). Aside from the training data and the inference data, the capability information may include any information or data from among (Z1) to (Z7). The gNB 200 may transmit the data type information used as a dataset, to the UE 100 as the control data. The data type information may include, for example, any of the data or information indicated in (Z1) to (Z7). Aside from the training data and the inference data, the data type information may include any information or data from among (Z1) to (Z7).

### (1.4) Other Arrangement Examples

Other arrangement examples will be described next.

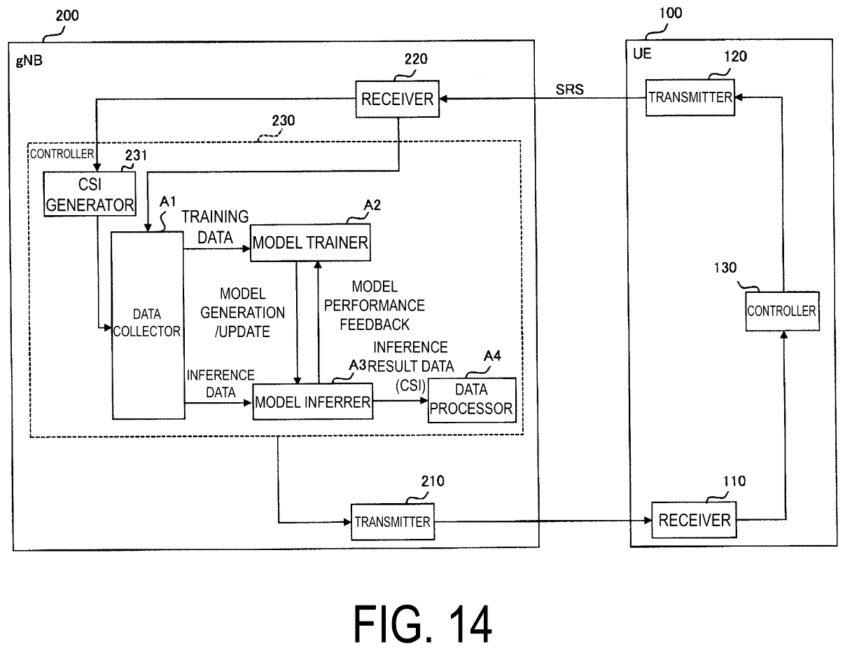

FIG. 14 is a diagram illustrating another arrangement example of the “CSI feedback enhancement” according to the first embodiment. FIG. 14 illustrates an example in which the gNB 200 includes the data collector A1, the model trainer A2, the model inferrer A3, and the data processor A4. In other words, FIG. 14 illustrates an example in which the gNB 200 performs model training and model inference. FIG. 14 illustrates an example in which the transmission entity TE is the gNB 200 and the reception entity RE is the UE 100.

FIG. 14 illustrates an example in which the AI/ML technology is introduced into CSI estimation performed by a gNB 200 based on a Sounding Reference Signal (SRS). Thus, the gNB 200 includes a CSI generator 231 that generates CSI based on the SRS. The CSI is information indicating an uplink channel state between the UE 100 and the gNB 200. The gNB 200 (for example, the data processor A4) performs, for example, uplink scheduling based on the CSI generated based on the SRS.

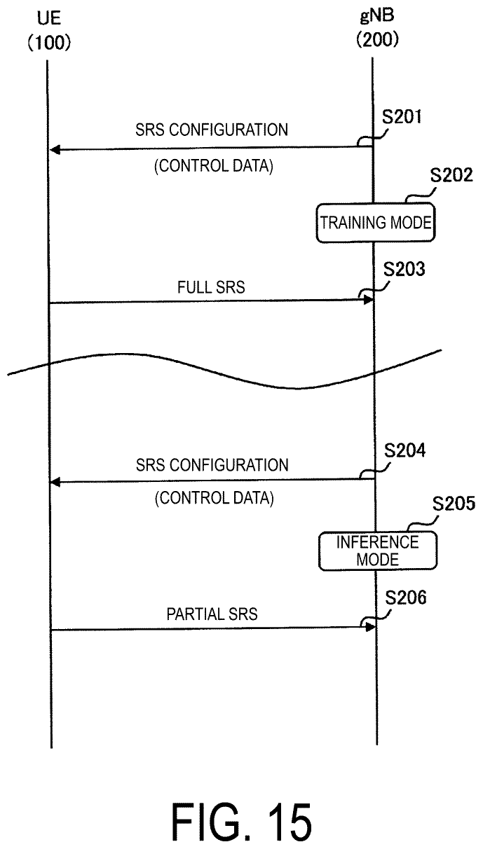

FIG. 15 is a diagram illustrating an operation example in another arrangement example according to the first embodiment.

As illustrated in FIG. 15, in step S201, the gNB 200 provides SRS configuration for the UE 100. The SRS transmission configuration may include type information of the reference signal transmitted by the UE 100.

In step S202, the gNB 200 starts the training mode.

In step S203, the UE 100 transmits a full SRS to the gNB 200 in accordance with the SRS transmission configuration (step S201). The receiver 220 of the gNB 200 receives the full SRS. In the training mode, the CSI generator 231 generates (or estimates) CSI based on the full SRS. The data collector A1 collects the full SRS and the CSI. The model trainer A2 uses the full SRS and the CSI as training data to generate a trained model.

In step S204, the gNB 200 specifies the transmission pattern (puncture pattern) of the SRS to be input to the trained model as the inference data, and configures the specified SRS transmission pattern for the UE 100. The gNB 200 may transmit, to the gNB 200, the SRS transmission configuration including the specified SRS transmission pattern.

In step S205, the gNB 200 switches from the training mode to the inference mode. The gNB 200 starts the model inference using the trained model.

In step S206, the UE 100 transmits the partial SRS in accordance with the SRS transmission configuration (step S204). When the gNB 200 inputs the SRS as the inference data to the trained model to obtain a channel estimation result, the gNB 200 performs uplink scheduling (for example, control of uplink transmission weights and the like) of the UE 100 by using the channel estimation result. Note that when the inference accuracy achieved by the trained model deteriorates, the gNB 200 may reconfigure the UE 100 to cause the UE 100 to transmit the full SRS.

(1.5) Arrangement Example when Federated Learning is Performed

An arrangement example of the functional blocks used when federated learning is performed will be described. The federated learning is, for example, one approach for machine learning in which machine learning is performed in a state where data (or a dataset) is not aggregated but distributed. In the federated learning, each entity does not need to transmit data, and thus the security of the entity can be ensured. The federated learning is considered to be able to obtain a training result with accuracy equivalent to that of the conventional centralized machine learning.

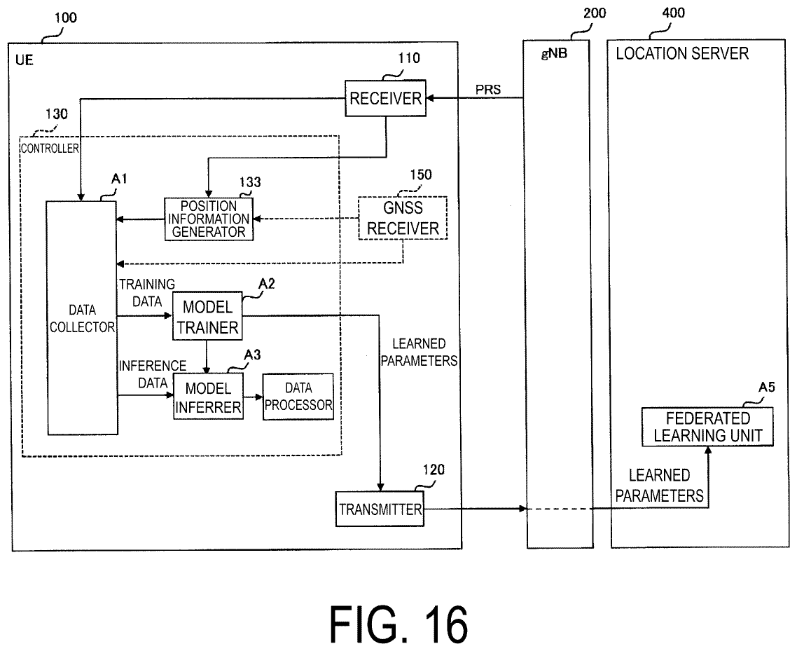

FIG. 16 is a diagram illustrating an arrangement example in which the federated learning according to the first embodiment is performed. The example illustrated in FIG. 16 illustrates an example of a case in which the position estimation of the UE 100 is performed using the federated learning. FIG. 16 illustrates an example in which the UE 100 includes the data collector A1, the model trainer A2, and the model inferrer A3. In other words, FIG. 16 illustrates an example in which the UE 100 performs model training and model inference. FIG. 16 illustrates an example in which the UE 100 is the transmission entity TE and the gNB 200 and/or a location server 400 is the reception entity RE.

The federated learning illustrated in FIG. 16 is performed in the following procedure, for example.

First, the location server 400 transmits, to the UE 100, the model on which model training is based.

Second, the UE 100 (model trainer A2) performs model training using the data present in the UE 100. The data present in the UE 100 may be, for example, a PRS received from the gNB 200 and/or output data (GNSS signal) from the GNSS reception device 150. The data present in the UE 100 may include position data generated by the position information generator 133 based on the reception result of the PRS and/or the output data from the GNSS reception device 150.

Third, the UE 100 applies the trained model, which is the training result, to the model inferrer A3 and transmits, to the location server 400, variable parameters included in the trained model (hereinafter also referred to as “learned parameters”). In the above example, the optimized a (slope) and b (intercept) correspond to the learned parameters.

Fourth, the location server 400 (federated learning unit A5) collects the learned parameters from a plurality of UEs 100 and integrates these parameters. The location server 400 may transmit, to the UE 100, the trained model obtained by the integration. The location server 400 can estimate the position of the UE 100 based on the trained model and a measurement report from the UE 100.

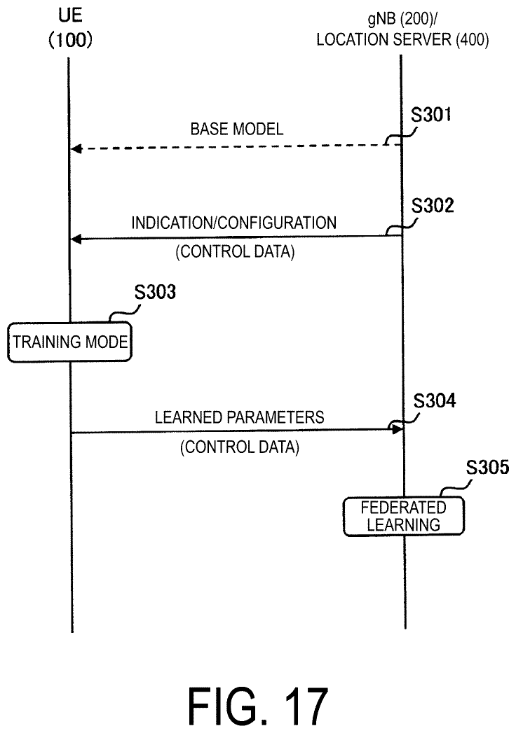

FIG. 17 is a diagram illustrating an operation example in the federated learning according to the first embodiment.

As illustrated in FIG. 17, in step S301, the gNB 200 may notify the UE 100 of a model on which learning of the UE 100 is based. The location server 400 may notify the UE of the model via the gNB 200.

In step S302, the gNB 200 indicates the UE 100 about model training. The gNB 200 may configure a report timing (trigger condition) of the learned parameters. The report timing may be a periodic timing. The report timing may be a timing triggered by learning proficiency satisfying a condition (i.e., an event trigger).

In step S303, the UE 100 starts the training mode. The UE 100 performs model training using, as the training data, the full PRS (or the full GNSS signal) and the position data generated by the position information generator 133.

In step S304, when the condition of the report timing is satisfied, the UE 100 transmits, to the network (gNB 200 or location server 400) the learned parameters obtained at that time.

In step S305, the location server 400 integrates the learned parameters reported from a plurality of UEs 100.

### (1.6) Model Transfer Example

In (1.1) to (1.5), the arrangement example of the functional blocks of the AI/ML technology has been described. A model transfer example will be described below. The model to be transferred may be a trained model used in the model inference. The model may be an untrained model used in the model training (or a model being trained).

### (1.6.1) First Operation Pattern Relating to Model Transfer

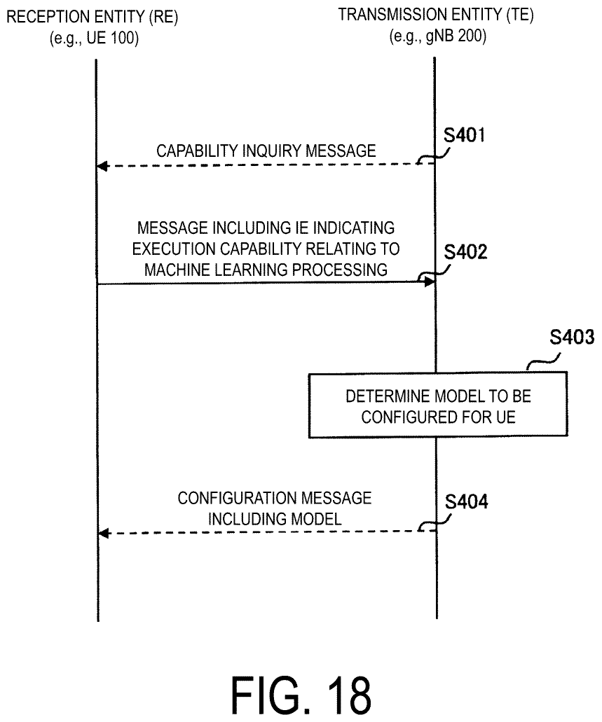

FIG. 18 is a diagram illustrating an operation example of a first operation pattern relating to model transfer according to the first embodiment. In the example illustrated in FIG. 18, the reception entity RE is mainly described as the UE 100. However, the reception entity RE may be the gNB 200 or AMF 300. In the example illustrated in FIG. 18, the transmission entity TE is mainly described as the gNB 200. However, the transmission entity TE may be the UE 100 or AMF 300.

As illustrated in FIG. 18, in step S401, the gNB 200 transmits, to the UE 100, a capability inquiry message for requesting transmission of the message including the information element (IE) indicating the execution capability relating to the machine learning processing. The UE 100 receives the capability inquiry message. However, the gNB 200 may transmit the capability inquiry message when performing the machine learning processing (when determining to perform the machine learning process).

In step S402, the UE 100 transmits, to the gNB 200, the message including the information element indicating the execution capability (an execution environment for the machine learning processing, from another viewpoint) relating to the machine learning processing. The gNB 200 receives the message. The message may be an RRC message, for example, a “UE Capability” message or a newly defined message (for example, a “UE AI Capability” message or the like). Alternatively, the transmission entity TE may be the AMF 300 and the message may be a NAS message. When a new layer for performing or controlling the machine learning processing (AI/ML processing) is defined, the message may be a message of the new layer.

The information element indicating the execution capability relating to the machine learning processing may be an information element indicating capability of a processor for performing the machine learning processing and/or an information element indicating capability of a memory for performing the machine learning processing. Specifically, the information element indicating the capability of the processor may be an information element indicating a product number (or model number) of an AI processor. Specifically, the information element indicating the capability of the memory may be an information element indicating the memory capacity.

Alternatively, the information element indicating the execution capability relating to the machine learning processing may be an information element indicating the execution capability of the inference processing (model inference). The information element indicating the execution capability of the inference processing may be an information element indicating whether a deep neural network model can be supported. The information element may indicate the time (response time) required to execute the inference processing.

Alternatively, the information element indicating the execution capability relating to the machine learning processing may be an information element indicating the execution capability of the learning processing (model training). The information element indicating the execution capability of the learning processing may be an information element indicating the number of simultaneous executions of the learning processing. The information element may indicate the processing capacity of the learning processing.

In step S403, the gNB 200 determines a model to be configured (or deployed) for the UE 100 based on the information element included in the message received in step S402.

In step S404, the gNB 200 transmits, to the UE 100, a message including the model determined in step S403. The UE 100 receives the message and performs the machine learning processing (i.e., model training processing and/or model inference processing) using the model included in the message. A specific example of step S404 will be described in a second operation pattern below.

### (1.6.2) Second Operation Pattern Relating to Model Transfer

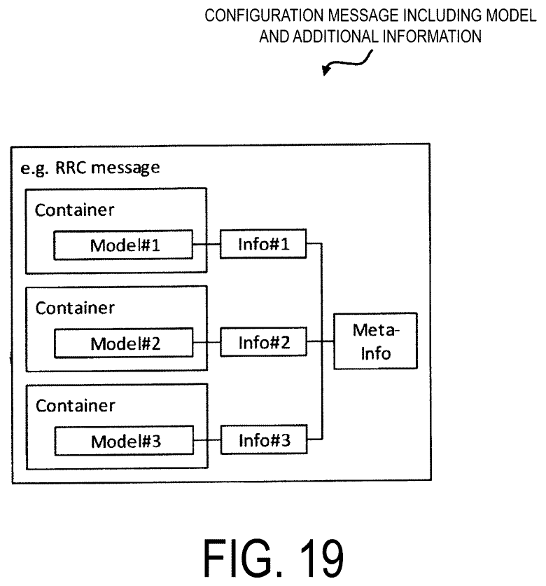

FIG. 19 is a diagram illustrating an example of a configuration message including models and additional information according to the first embodiment. The configuration message may be an RRC message transmitted from the gNB 200 to the UE 100 (for example, an “RRC Reconfiguration” message, or a newly defined message (for example, an “AI Deployment” message, an “AI Reconfiguration” message, or the like)). Alternatively, the configuration message may be a NAS message transmitted from the AMF 300 to the UE 100. When a new layer for performing or controlling the machine learning processing (AI/ML processing) is defined, the message may be a message of the new layer.

In the example of FIG. 19, the configuration message includes three models (Model #1 to Model #3). Each model is included as a container of the configuration message. However, the configuration message may include only one model. The configuration message further includes, as the additional information, three pieces of individual additional information (Info #1 to Info #3) individually provided corresponding to three models (Model #1 to Model #3), respectively, and common additional information (Meta-Info) commonly associated with three models (Model #1 to Model #3). Each piece of individual additional information (Info #1 to Info #3) includes information unique to the corresponding model. The common additional information (Meta-Info) includes information common to all models in the configuration message.

The individual additional information may be a model index representing an index (index number) assigned to each model. The individual additional information may be a model execution condition indicating performance (for example, processing delay) required for applying (executing) the model.

The individual additional information or the common additional information may be a model application designating a function to which the model is applied (for example, “CSI feedback”, “beam management”, “position measurement”, or the like). The individual additional information or the common additional information may be a model selection criterion for applying (executing) a corresponding model in response to satisfaction of a designated criterion (for example, a moving speed).

(2) Communication Control Method according to First Embodiment

A communication control method according to the first embodiment will be described.

Currently, in 3GPP, life cycle management (LCM) (hereinafter, may be referred to as “LCM”) for an AI/ML model is being discussed in relation to the AI/ML technology.

The LCM is, for example, to manage a life cycle from generation of a target to management, operation, and deletion. The LCM for the AI/ML model enables, for example, data collection, learning, inference, and the like of the AI/ML model to be comprehensively managed and efficiently executed.

The LCM for the AI/ML model includes, for example, data collection, model training, model registration, model deployment, model configuration, model monitoring, and model inference operation.

Further, examples of the LCM for the AI/ML model include model selection, model activation, model deactivation, model switching, fallback from the AI/ML model to a non-AI/ML model, model update, and model transfer. The fallback of the model may be fallback to a default model (or a base model).

Such an operation for the AI/ML model may be referred to as an “LCM-related operation” hereinafter. Alternatively, such an operation for the AI/ML model may be simply referred to as “LCM” hereinafter.

Hereinafter, an example in which the “LCM-related operation” is any one of selection of a model, activation of a model, deactivation of a model, switching of a model, fallback from an AI/ML model to a non-AI/ML model, update of a model, or transfer of a model will be described.

Here, for example, the following case is assumed. That is, this is a case in which an LCM-related operation is performed in the UE 100. In such a case, when the UE 100 performs the LCM-related operation through its own determination regardless of an instruction from the network side, this may not necessarily be preferable. For example, regardless of the network side instructing the UE 100 to use a specific trained model, when the UE 100 selects another model or switches to another model, the UE 100 may not be able to use the trained model. In this case, the network side may need to perform extra processing such as transmitting the trained model to the UE 100.

Therefore, the first embodiment aims to enable the UE 100 to appropriately execute the LCM-related operation for the AI/ML model.

To this end, in the first embodiment, the model transmission entity (for example, the gNB 200) transmits to the model reception entity (for example, the UE 100) LCM operation disable information indicating whether life cycle management (LCM)-related operation is disabled for the AI/ML model and/or LCM operation condition information indicating an execution condition for the life cycle management (LCM)-related operation for the AI/ML model. Here, the life cycle management (LCM)-related operation is any one of selection of an AI/ML model, activation of the AI/ML model, deactivation of the AI/ML model, switching of the AI/ML model, fallback from the AI/ML model to a non-AI/ML model, update of the AI/ML model, or transfer of the AI/ML model.

Accordingly, for example, the UE 100 can perform life cycle management-related operation in accordance with the LCM operation disable information and/or the LCM operation condition information transmitted from the network side (for example, the gNB 200). Therefore, the UE 100 can perform the operation in accordance with an instruction from the network side, thereby enabling an appropriate LCM-related operation to be performed for the AI/ML model. It is also possible to control the operation in the UE 100 from the network side.

Here, the model transmission entity MTE refers to, for example, an entity that transmits the AI/ML model. The AI/ML model that is a transmission target may be an untrained model or a trained model. The model transmission entity MTE is, for example, the gNB 200. The model transmission entity MTE may also be a core network device.

On the other hand, the model reception entity MRE refers to, for example, an entity that receives the AI/ML model. The model reception entity MRE receives the AI/ML model transmitted from the model transmission entity MTE. The model reception entity MRE is, for example, the UE 100.

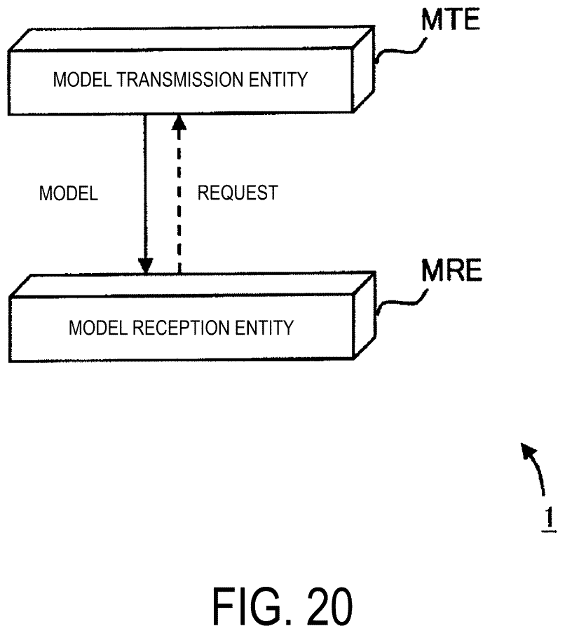

FIG. 20 is a diagram illustrating a configuration example of a mobile communication system 1 according to the first embodiment. As illustrated in FIG. 20, the mobile communication system includes the model transmission entity MTE and the model reception entity MRE.

When the model transmission entity MTE is the gNB 200, for example, the model transmission entity MTE may transmit the model by transmitting an RRC message including the model to the model reception entity MRE. Also, when the model transmission entity MTE is a core network device (for example, the AMF 300), the model transmission entity MTE may transmit the model by transmitting a predetermined message (for example, a NAS message) including the model to the model reception entity MRE.

As illustrated in FIG. 20, the model reception entity MRE may transmit request information for requesting transfer of the model to the model transmission entity MTE. The model transmission entity MTE may transmit the model in response to the model request information. When the model transmission entity MTE is the gNB 200, the model request information may be included and transmitted in control data. When the model transmission entity MTE is a core network device (for example, the AMF 300), the model request information may be included in a predetermined message (for example, a NAS message) and transmitted.

In particular, in the first embodiment, an example in which the model transmission entity MTE includes the LCM operation disable information and/or the LCM operation condition information in the model has been described. Specifically, an example in which the model transmission entity MTE (for example, the gNB 200) transmits an AI/ML model including the LCM operation disable information and/or the LCM operation condition information to the model reception entity MRE (for example, the UE 100) will be described. When the model transmission entity MTE transmits the model, the LCM operation disable information and/or the LCM operation condition information is received by the model reception entity MRE.

### LCM Operation Disable Information and LCM Operation Condition Information

Here, specific examples of the LCM operation disable information and the LCM operation condition information will be described.

The LCM operation disable information is, for example, information indicating whether or not the LCM-related operation is disabled for the model, as described above.

First, the LCM operation disable information may be information indicating that the LCM-related operation is disabled. For example, when the model includes the LCM operation disable information indicating that the LCM-related operation is disabled, this indicates that the operation is disabled for that model, that is, that there is no need to execute the operation for the model.

Second, the LCM operation disable information may be information indicating that the LCM-related operation may be performed. For example, when the model includes the LCM operation disable information indicating that the LCM-related operation may be performed, this indicates that the operation may be performed for the model.

Third, the LCM operation disable information may be information indicating that an LCM-related operation may be performed, provided that the execution conditions for the LCM-related operation are satisfied. For example, when the model includes the LCM operation disable information, this indicates that the operation may be executed for the model, provided that the execution condition is satisfied. In this case, the model includes the LCM operation condition information indicating the execution condition, together with the LCM operation disable information.

Fourth, the LCM operation disable information may be information indicating that it is necessary for the operation to be forcibly executed for the model, provided that the execution condition for the LCM-related operation is satisfied. For example, when the model includes the LCM operation disable information, this indicates that the operation will be forcibly executed for the model, provided that the execution condition is satisfied. In this case, the model also includes LCM operation condition information together with the LCM operation disable information.

On the other hand, the execution condition for the LCM-related operation is, for example, as shown in the following table.

TABLE 1

| Execution condition | Application example |
|---|---|
| Time, timing, or use | Time: This indicates an expiration date. This indicates that for example, |
| frequency | when the execution condition is “2023 June”, the LCM is available until May |
| | 2023, and is not available after June 2023, and the LCM-related operation |
| | is available (or the operation may be available until June 2023). |
| | Use frequency: This indicates that, for example, when the use frequency is |
| | “7 days”, a model that has not been used for 7 days or more can operate |
| | (or vice versa). |
| | The time or timing may be determined by a period in which the model is |
| | activated or a period in which the model is deactivated. |
| | The time, timing, or use frequency may be indicated by a range. In this |
| | case, this may indicate that the operation is possible within the range (or, |
| | conversely, the operation may be possible when the range is exceeded). |
| Place, position, or | The execution condition may be indicated by GPS location information, |
| affiliation | a place name, a cell name (or cell ID), a tracking area information (TAI), |
| | a registration area (RA), or a public land mobile network number |
| | (PLMN). For example, when the execution condition is “TA #1”, the |
| | operation becomes possible when moving away from TA #1 (or |
| | conversely, the operation may be possible within TA #1). The execution |
| | condition may be indicated by a place, a position, or a range of affiliation, |
| | and in this case, the operation may be possible within the range (or |
| | outside the range). |
| Moving speed | This indicates a moving speed of the object (for example, the UE 100). |
| | This may indicate that, in the case of “40 km” as the execution condition, |
| | the operation is possible when the moving speed becomes equal to or |
| | lower than 40 km (or equal to or higher than 40 km) (for a model |
| | dedicated to a high-speed moving train). The moving speed may be |
| | indicated by a range, and in this case, this may indicate that the operation |
| | is possible within (or outside) the range. |
| Altitude | This indicates an altitude of an object (for example, the UE 100). The |
| | altitude may represent a height from the ground or may represent a height |
| | from a sea level of 0 m. This indicates that, in the case of “altitude 0 m” as |
| | the execution condition, when the altitude becomes “0 m”, that is, after |
| | landing, the operation is possible (or the operation is impossible) (because |
| | of a model dedicated to the time of aircraft movement). The altitude may |
| | be indicated by a range, and this may indicate that the operation can be |
| | performed within (or outside) the range. |
| Computing resource | This indicates a remaining storage memory capacity (ROM). When a |
| | storage memory capacity becomes equal to or less than the remaining |
| | memory capacity (or less than the memory capacity), this may indicate that |
| | the operation is possible. This may also indicate a temporary storage |
| | capacity (RAM), CPU resources (usage state percentage of CPU). |
| Slice information | This indicates slices in which the LCM-related operation is possible. |
| | Slice information is represented by, for example, a Network Slice AS |
| | Group (NASG), Network Slice Selection Assistance Information |
| | (NSSAI), or Single-Network Slice Selection Assistance Information (S-NSSAI). |
| | For example, when the UE 100 uses a model by using the slice |
| | indicated by the slice information, the slice information indicates that the |
| | operation is possible for the model. |

The LCM operation disable information and/or the LCM operation condition information may be referred to as “LCM operation information” hereinafter.

### Operation Example According to First Embodiment

Next, an operation example according to the first embodiment will be described.

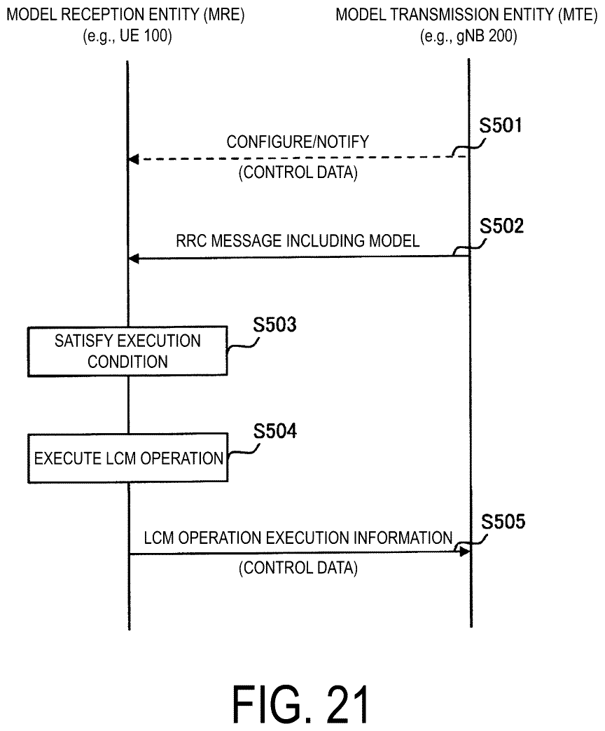

FIG. 21 is a diagram illustrating an operation example according to the first embodiment. As illustrated in FIG. 21, an example in which the model transmission entity MTE is the gNB 200 and the model reception entity MRE is the UE 100 will be described.

In step S501, the gNB 200 uses control data to perform configuration or notification for the UE 100. The gNB 200 may configure or notify the UE 100 of switching to an inference mode. The gNB 200 may also perform configuration or notification of puncture pattern or the like used in “CSI feedback” or the like.

In step S502, the gNB 200 includes the LCM operation information in a model and transmits the model including the LCM operation information to the UE 100 using an RRC message.

The gNB 200 includes the LCM operation information in the model. Specifically, the LCM operation information may be included in file data including the model. For example, when the model itself is included in the file data, the gNB 200 includes the LCM operation information in the file data. Alternatively, the LCM operation information may be added to a model ID that identifies the model. For example, the gNB 200 may add the LCM operation information to the model ID, include the model ID including the LCM operation information in individual additional information (FIG. 19) (or include the model ID as the individual additional information), and transmit the individual additional information to the UE 100. Alternatively, the LCM operation information may be included in meta information of the model. For example, the gNB 200 may include the meta information including the LCM operation information in the common additional information (Meta-Info) (FIG. 19) (or include the meta information as the common additional information) and transmit the common additional information to the UE 100.

In step S503, the UE 100 enters a state in which the execution conditions are satisfied. The UE 100 may notify the gNB 200 that the UE 100 has entered the state in which the execution conditions are satisfied (or that the UE 100 desires the execution). The notification may include one or more of a model identifier for identifying the model, an execution condition identifier for identifying the execution condition, information indicating the execution condition that has been satisfied, or information indicating the condition (cause). The notification may be transmitted when the execution condition is satisfied (triggered). The notification may be transmitted using control data. When the gNB 200 receives the notification and executes control of the LCM-related operation of the model, the gNB 200 may transmit an LCM control command to the UE 100. The LCM control command may also be transmitted using control data.

In step S504, the UE 100 executes the LCM-related operation. The UE 100 confirms that the execution condition included in the model is satisfied (step S503), and executes the LCM-related operation for the model. When the model does not include the execution condition but includes the LCM operation disable information, the UE 100 may execute the LCM-related operation for the model in accordance with the LCM operation disable information, regardless of whether the execution condition is satisfied. The UE 100 may confirm an available capacity of a memory and execute the LCM-related operation for the model when the available capacity falls below a capacity threshold.

The LCM operation information may be hard-coded. In this case, the LCM operation information is not transmitted from the gNB 200, and for example, the UE 100 may execute the LCM-related operation on the model in accordance with the execution condition defined in the specification.

Here, operation of steps S502 to S504 will be described for each LCM-related operation.

### When the LCM-Related Operation is “Selection”

In this case, the LCM operation disable information is information indicating whether a “selection” operation is disabled (step S502). The LCM operation information may include information indicating the LCM-related operation (here, “selection”).

Further, the execution condition is an execution condition for selecting a model. When the execution condition is satisfied (step S503), the UE 100 executes an operation to select a model (step S504). The model that is a selection target may be a model received in step S502. Identification information for the model that is a selection target may be included in the LCM operation information.

### When the LCM-Related Operation is “Activation”

In this case, the LCM operation disable information is information indicating whether “activation” is disabled (step S502). Information indicating the LCM-related operation (here, “activation”) may be included in the LCM operation information.

Further, the execution condition is an execution condition for activating the model. When the execution condition is satisfied (step S503), the UE 100 activates the model (step S504). The model that is an activation target may be the model received in step S502. Identification information for the model that is an activation target may be included in the LCM operation information.

When the LCM-related operation is “activation,” and the UE 100 does not satisfy the execution condition, the UE 100 may deactivate the model. The deactivation may be instructed through control data by the gNB 200. The identification information for the model that is a deactivation target may be included in the control data. When the UE 100 deactivates the model, the UE 100 may transmit information indicating that the model has been deactivated to the gNB 200 as the control data.

### When the LCM-Related Operation is “Deactivation”

In this case, the LCM operation disable information is information indicating whether “deactivation” is disabled (step S502). Information indicating the LCM-related operation (here, “deactivation”) may be included in the LCM operation information.

Further, the execution condition is an execution condition for deactivating the model. When the execution condition is satisfied (step S503), the UE 100 deactivates the model (step S504). The model that is a deactivation target may be the model received in step S502. Identification information for the model that is a deactivation target may be included in the LCM operation information.

When the LCM-related operation is “deactivation” and the UE 100 does not satisfy the execution condition, the UE 100 may activate the model. The activation may be instructed through control data by the gNB 200. The identification information for the model that is an activation target may be included in the control data. When the UE 100 activates the model, the UE 100 may transmit information indicating that the model has been activated to the gNB 200 as the control data.

### When the LCM-Related Operation is “Switching”

In this case, the LCM operation disable information indicates whether “switching” is disabled (step S502). The LCM operation information may include information indicating the LCM-related operation (here, “switching”).

Further, the execution condition serves as an execution condition for switching models. When the execution condition is satisfied (step S503), the UE 100 switches the model from model A to model B (step S504). A switching source model A may be a model currently being executed by the UE 100. On the other hand, a switching destination model B may be the model received in step S502. Identification information for the switching source model and/or the switching destination model may be included in the LCM operation information.

### When the LCM-Related Operation is “Fallback”

In this case, the LCM operation disable information is information indicating whether “fallback” is disabled (step S502). Information indicating the LCM-related operation (here, “fallback”) may be included in the LCM operation information.

Further, the execution condition serves as an execution condition for fallback from the AI/ML model to the non-AI/ML model. When the execution condition is satisfied (step S503), the UE 100 falls back the model from the AI/ML model to the non-AI/ML model (step S504). Identification information for the non-AI/ML model that is a fallback target may be included in the execution condition or the LCM operation information.

### When the LCM-Related Operation is “Update”

In this case, the LCM operation disable information is information indicating whether “update” is disabled (step S502). Information indicating the LCM-related operation (here, “update”) may be included in the LCM operation information.

Further, the execution condition serves as an execution condition for updating the model. When the execution condition is satisfied (step S503), the UE 100 executes an operation to update the model (step S504). The model before update may be the model received in step S502. In this case, when the UE 100 starts executing the update operation, the UE 100 may transmit an update request to the gNB 200 using a control message and acquire the updated model from the gNB 200 as in step S502. The updated model may be the model received in step S502. In this case, when the execution condition is satisfied (step S503), the UE 100 updates the currently executed model into the model received in step S502 (step S504).

### When the LCM-Related Operation is “Transmission”

In this case, the LCM operation disable information is information indicating whether “transmission” is disabled (step S502). Information indicating the LCM-related operation (here, “transmission”) may be included in the LCM operation information.

Further, the execution condition is an execution condition for transmitting the model. When the execution condition is satisfied (step S503), the UE 100 executes an operation to transmit the model to the gNB 200 (step S504). The UE 100 may execute the transfer of the model by transmitting an RRC message including the model to the gNB 200. Identification information for the model that is a transmission target may be included in the execution conditions or the LCM operation information and instructed by the gNB 200.

When the LCM-related operation as described above is executed, the UE 100 transmits the LCM operation execution information to the gNB 200 in step S505. The LCM operation execution information is, for example, information indicating that the LCM-related operation has been executed on the model. The LCM operation execution information may include information indicating which LCM-related operation (any one of selection, activation, deactivation, switching, fallback, or transmission) has been executed. In this case, the UE 100 may transmit information for specifying the model that has performed the operation to the gNB 200. The information may be specified by a model ID, model name, model identification information, or the like. The information may be included in the LCM operation execution information. In subsequent embodiments, the information for specifying the model that has performed the operation is similarly transmitted when the LCM operation execution information is transmitted. The LCM operation execution information may be transmitted as the control data.

### Other Operation Example 1 According to First Embodiment

In the first embodiment, an example in which the model transmission entity MTE is the gNB 200 has been described, but the model transmission entity MTE is not limited to the gNB 200. For example, the model transmission entity MTE may be a core network device. The core network device transmits a predetermined message including the model (step S502), but in this case, the core network device includes the LCM operation information in the model and transmits the model. When the UE 100 executes the LCM-related operation on the model, the UE 100 includes the LCM operation execution information in a predetermined message (the NAS message when the model transmission entity MTE is the AMF 300) and transmits the message to the core network device.

### Other Operation Example 2 According to First Embodiment

The model transmission entity MTE may be an over-the-top (OTT) server device. The OTT server device is, for example, a server device that is present outside the core network device and provides content service such as a messages, voice, or video. The OTT server device can transmit the model to the UE 100 using a predetermined signaling message. The OTT server device includes the LCM operation information in the model and transmits a message including the model to the UE 100 (step S502). When the UE 100 executes the LCM-related operation for the model, the UE 100 transmits a message including the LCM operation execution information to the OTT server device (step S505).

### Second Embodiment

Next, a second embodiment will be described. In the second embodiment, differences from the first embodiment will be mainly described.

In the first embodiment, an example in which the LCM operation information is included in the model and the model is transmitted so that the LCM operation information is transmitted has been described. In the second embodiment, an example in which the LCM operation information is transmitted by signaling, separate from the transfer of the model will be described.

Specifically, first, the model transmission entity (for example, the gNB 200) transmits the AI/ML model to the model reception entity (for example, the UE 100). Second, the model transmission entity transmits a message including the LCM operation disable information and/or the LCM operation condition information to the model reception entity.

Accordingly, for example, in the second embodiment, since the UE 100 can receive the LCM operation information, it is possible to perform the LCM-related operation on the model in accordance with the LCM operation information, as in the first embodiment. Therefore, the UE 100 executes the operation for the model in accordance with the instruction from the network side, it is possible to appropriately execute the operation for the model.

### Example of Transmission of LCM Operation Information According to Second Embodiment

In the second embodiment, the LCM operation information can be transmitted to the model reception entity MRE not only from the model transmission entity MTE but also from other entities.

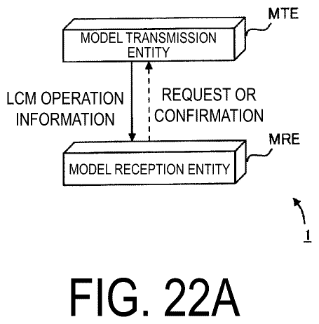

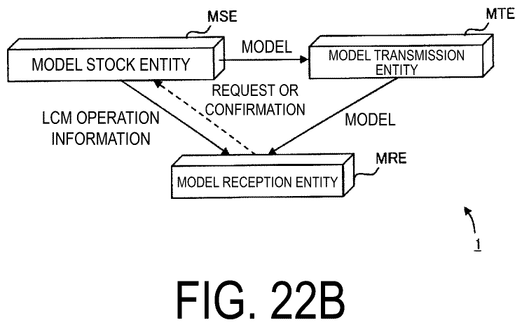

FIGS. 22A and 22B are diagrams illustrating a configuration example of a mobile communication system 1 according to the second embodiment. Of these, FIG. 22A illustrates an example in which the model transmission entity MTE transmits the LCM operation information to the model reception entity MRE, as in the first embodiment. In this case, the model reception entity MRE may transmit a request for the LCM operation information to the model transmission entity MTE. The model reception entity MRE may confirm with the model transmission entity MTE whether the LCM operation information has been transmitted. When the model reception entity MRE is the UE 100 and the model transmission entity MTE is the gNB 200, the request and the confirmation may be transmitted using a control message. Further, when the model reception entity MRE is the UE 100 and the model transmission entity MTE is a core network device (for example, the AMF 300), the request and the confirmation may be performed using a predetermined message (for example, an NAS message). The model transmission entity MTE may transmit the LCM operation information to the model reception entity MRE in response to the request or the confirmation. Thus, the transmission of the LCM operation information, the request, and the confirmation may be performed using signaling between the model transmission entity MTE and the model reception entity MRE.

FIG. 22B shows an example in which the model stock entity MSE transmits the LCM operation information to the model reception entity MRE. The model stock entity MSE is, for example, an entity that stocks the AI/ML model. The model stock entity MSE may store all of the AI/ML models in the mobile communication system 1. In FIG. 22B, when the model transmission entity MTE is the gNB 200, the model stock entity MSE may be a core network device. Alternatively, the model stock entity MSE may be an OTT server device.

The model transmission entity MTE acquires the model from the model stock entity MSE and transmits the model to the model reception entity MRE. The model transmission entity MTE may request the model stock entity MSE to acquire the model. The model stock entity MSE may transmit the model to the model transmission entity MTE in response to the request.

The model stock entity MSE transmits a predetermined message including the LCM operation information (the NAS message when the model stock entity MSE is the AMF 300) to the model reception entity MRE. The model reception entity MRE may request the model stock entity MSE to transmit the LCM operation information. The model reception entity MRE may confirm with the model stock entity MSE whether or not the LCM operation information has been transmitted. The request and the confirmation may also be performed using a predetermined message. The model stock entity MSE may transmit the LCM operation information to the model reception entity MRE in response to receiving the request or the confirmation.

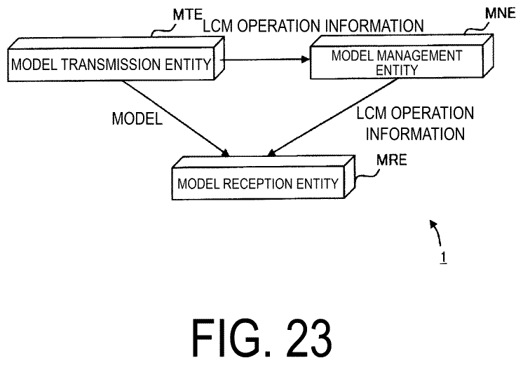

FIG. 23 is a diagram illustrating a configuration example of the mobile communication system 1 according to the second embodiment. FIG. 23 illustrates an example in which the model management entity MNE transmits the LCM operation information to the model reception entity MRE.

The model management entity MNE is, for example, an entity that manages the AI/ML model used in the mobile communication system 1. The model transmission entity MTE transmits the model to the model reception entity MRE and transmits the LCM operation information to the model management entity MNE. The model management entity MNE receives the LCM operation information and transmits the LCM operation information to the model reception entity MRE.

The model management entity MNE may be a core network device or may be an OTT server device. The model management entity MNE may transmit the LCM operation information by transmitting a predetermined message (an NAS message when the model management entity MNE is the AMF 300) including the LCM operation information to the model reception entity MRE. The model reception entity MRE may perform a request for transmission of the LCM operation information and confirmation of whether or not the LCM operation information has been transmitted, with respect to the model transmission entity MTE.

### Operation Example According to Second Embodiment

Next, an operation example according to the second embodiment will be described.

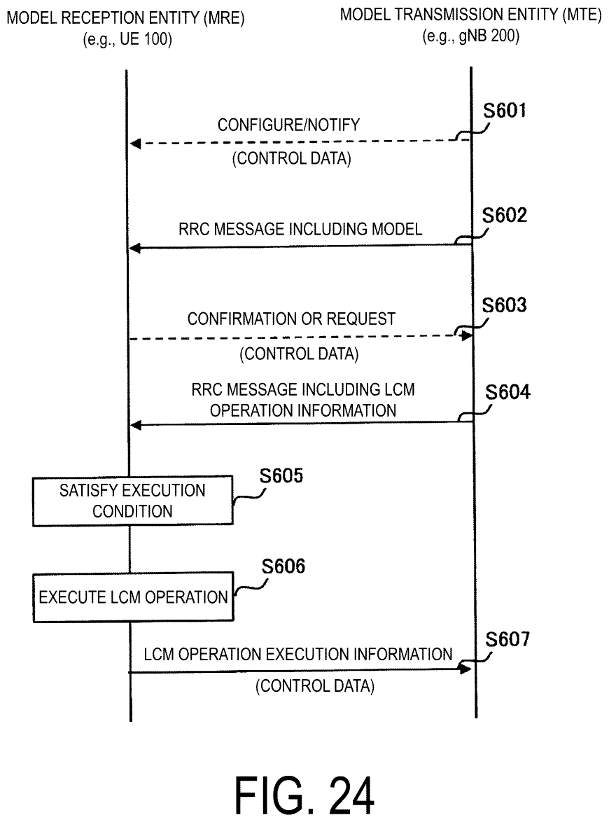

FIG. 24 is a diagram illustrating an operation example according to the second embodiment. As illustrated in FIG. 24, the operation example will be described using an example (FIG. 22A) in which the model transmission entity MTE is the gNB 200 and the model reception entity MRE is the UE 100.

Step S601 is the same as step S501 in the first embodiment.

In step S602, the gNB 200 transmits the RRC message including the model to the UE 100. In the second embodiment, the model does not include the LCM operation information.

In step S603, the UE 100 may request the gNB 200 to transmit the LCM operation information. In step S603, the UE 100 may confirm with the gNB 200 whether or not to transmit the LCM operation information. The UE 100 may perform the request and the confirmation using the control message. In this case, the UE 100 may transmit to the gNB 200 information for specifying whether to confirm transmission or non-transmission of the LCM operation information to which model. The information may be specified by a model ID, model name, or model identification information. The information may be included in the control message. In subsequent embodiments, transmission of the information for specifying whether to confirm transmission or non-transmission of the LCM operation information to which model is similarly performed when confirming transmission or non-transmission of the LCM operation information.

In step S604, the gNB 200 transmits an RRC message including the LCM operation information to the UE 100. The LCM operation information may include information indicating which LCM-related operation (any one of selection, activation, deactivation, switching, fallback, update, or transmission) the LCM operation information is for. In this case, the gNB 200 may transmit to the UE 100 information for specifying the model that is a target of the LCM-related operation. The information may be specified by a model ID, model name, or model identification information. The information may be included in the LCM operation information. In subsequent embodiments, when the LCM operation information is transmitted, information for specifying the model that is the target of the LCM-related operation is similarly transmitted.

In step S605, the UE 100 enters a state in which the execution condition is satisfied. In this case, as in the first embodiment, the UE 100 may notify the gNB 200 that the execution condition is satisfied (or that execution is desired). The content of the notification and a trigger for transmitting the notification may also be the same as in the first embodiment. As in the first embodiment, the gNB 200 may receive the notification and may transmit the LCM control command to the UE 100 when control of the LCM-related operation of the model is executed. The notification and the LCM control command may also be transmitted using the control data, as in the first embodiment.

In step S606, the UE 100 executes the LCM-related operation. When the LCM operation information includes the LCM operation disable information but not the LCM operation condition information, the UE 100 may execute the LCM-related operation for the model in accordance with the LCM operation disable information, regardless of whether the execution condition is satisfied.

The execution of each LCM-related operation (selection, activation, deactivation, switching, fallback, update, and transmission) in step S606 may be the same as step S504 (FIG. 21) in the first embodiment.

In step S607, the UE 100 transmits the LCM operation execution information to the gNB 200.

### Other Operation Example 1 According to Second Embodiment

In the second embodiment, an example in which the gNB 200 transmits the RRC message including the LCM operation information to the UE 100 (step S604) has been described. For example, instead of the gNB 200 transmitting the RRC message to the UE 100 (step S604), the model stock entity MSE may transmit a predetermined message including the LCM operation information (the NAS message when the model stock entity MSE is the AMF 300) (FIG. 22B).

Alternatively, the model management entity MNE may transmit a predetermined message including the LCM operation information (the NAS message when the model management entity MNE is the AMF 300) (for example, a second message) (FIG. 23), instead of the gNB 200 transmitting the RRC message to the UE 100 (step S604). In this case, the model management entity MNE may transmit a predetermined message including the LCM operation information to the UE 100 in response to receiving the predetermined message including the LCM operation information received from the model transmission entity MTE (for example, an N11 message when the model management entity MNE is the AMF 300 and the model transmission entity MTE is the gNB 200) (for example, a first message).

### Other Operation Example 2 According to Second Embodiment

In the second embodiment, an example in which the UE 100 requests the gNB 200 to transmit the LCM operation information and confirms whether the LCM operation information has been transmitted has been described, but the present invention is not limited to this example. For example, the UE 100 may transmit the request and the confirmation to the model stock entity MSE (step S603). In this case, the UE 100 may perform the request or the confirmation using a message (the NAS message when the model stock entity MSE is the AMF 300).

### Other Operation Example 3 According to Second Embodiment

In the second embodiment, an example in which the model transmission entity MTE is the gNB 200 has been described, but the model transmission entity MTE is not limited to the gNB 200. For example, the model transmission entity MTE may be a core network device. The core network device transmits the message including the model (step S602) and transmits the predetermined message including the LCM operation information (step S602). When the UE 100 executes the LCM-related operation for the model, the UE 100 transmits a message including the LCM operation execution information to the core network device (step S607).

### Other Operation Example 4 According to Second Embodiment

The model transmission entity MTE may be an OTT server device. The OTT server device transmits the message including the model to the UE 100 (step S602) and transmits the message including the LCM operation information to the UE 100 (step S604). When the UE 100 executes the LCM-related operation for the model, the UE 100 transmits the message including the LCM operation execution information to the OTT server device (step S607).

### Third Embodiment

Next, a third embodiment will be described. The third embodiment will be described with differences from the first embodiment and the second embodiment focused on.

For example, when the UE 100 is configured to perform the LCM-related operation on the model in accordance with the LCM operation information, the UE 100 can perform that operation on the model using the methods described in the first and second embodiments.

However, when the UE 100 does not have a specification for performing the operation in accordance with the LCM operation information, such as UE with a Rel-17 specification or UE with a Rel-16 specification, the UE 100 may continue to execute model inference without performing the operation. For example, even when the gNB 200 transmits the LCM operation information to the UE 100 and the UE 100 satisfies the execution conditions, the UE 100 may continue to perform the model inference without executing the operation for the model.

Therefore, in the third embodiment, an example in which the UE 100 transmits the LCM operation permission information indicating whether or not execution of the LCM-related operation is permitted to the gNB 200 when the execution condition is satisfied, even when the UE 100 is not configured to perform the operation in accordance with the LCM operation information will be described.

Specifically, first, the model reception entity (for example, the gNB 200) receives the LCM operation disable information and the LCM operation condition information. Second, when the model reception entity executes model inference using the AI/ML model without executing the operation for the AI/ML model regardless of the execution condition being satisfied, the model reception entity transmits the LCM operation permission information indicating whether the operation may be executed for the AI/ML model to the model transmission entity (for example, the gNB 200) together with or instead of the inference result data.

Accordingly, for example, the gNB 200 can ascertain that the UE 100 executes the LCM-related operation for the model based on the LCM operation permission information. Therefore, since the gNB 200 can ascertain execution of the operation for the model, the UE 100 can appropriately execute the operation for the model.

### Operation Example According to Third Embodiment

Next, an operation example according to the third embodiment will be described.

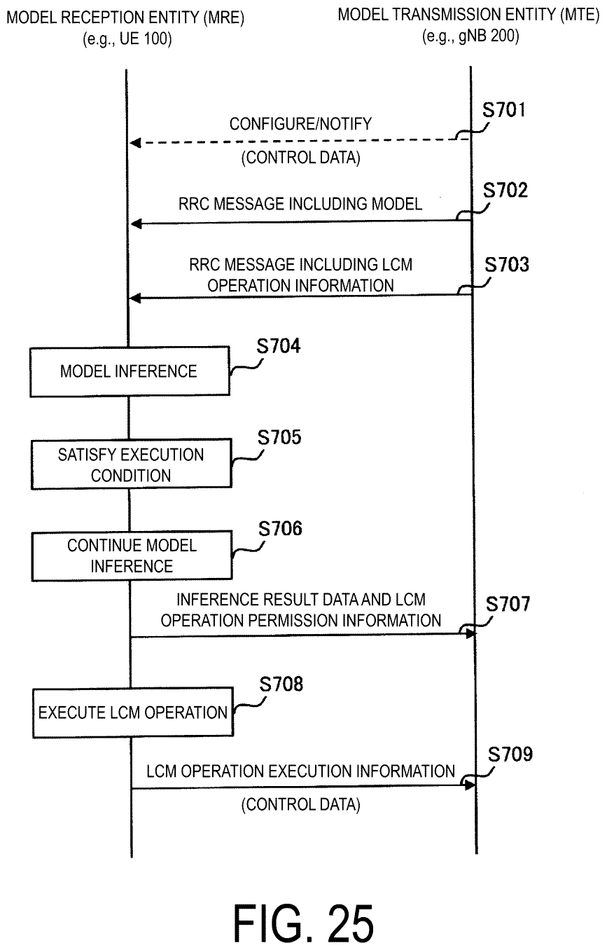

FIG. 25 is a diagram illustrating an operation example according to the third embodiment. As illustrated in FIG. 25, the operation example will be described using an example in which the model transmission entity MTE is the gNB 200 and the model reception entity MRE is the UE 100.

Step S701 is the same as step S601 in the second embodiment, step S702 is the same as step S602 in the second embodiment, and step S703 is the same as step S604 in the second embodiment. The UE 100 may confirm or request the LCM operation information (step S603), as in the second embodiment.

In step S704, the UE 100 performs model inference using the model (step S702).

In step S705, the UE 100 enters a state in which the execution condition is satisfied.

In step S706, the UE 100 continues to execute the model inference regardless of the execution condition being satisfied.

In step S707, the UE 100 transmits the LCM operation permission information to the gNB 200 together with the inference result data. For example, the controller 130 of the UE 100 compares the inference result data with the execution condition, and transmits the LCM operation permission information when the inference result data satisfies the execution condition (for example, when the inference result data is location information outside an “area” shown as the execution conditions). Alternatively, when the model inferrer A3 outputs an error result instead of the inference result data, the controller 130 may transmit the LCM operation permission information instead of the inference result data. The UE 100 may transmit the inference result data as user data and transmit the LCM operation permission information as the control data.

When the UE 100 transmits the LCM operation permission information, the UE 100 may also transmit cause information (Cause) indicating a reason for transmitting the LCM operation permission information to the gNB 200. The cause information may be, for example, that a “period” shown as the execution condition has been exceeded, or that location information outside the “area” shown as the execution condition has been acquired.

In step S708, the UE 100 executes the LCM-related operation (specifically, any one of selection, activation, deactivation, switching, fallback, update, or transmission) for the model.

In step S709, the UE 100 transmits the LCM operation execution information to the gNB 200.

### Other Operation Example 1 According to Third Embodiment

In the third embodiment, the model stock entity MSE may transmit the predetermined message including the LCM operation information (the NAS message when the model stock entity MSE is the AMF 300) (FIG. 22B) instead of the gNB 200 transmitting the RRC message including the LCM operation information to the UE 100 (step S703), as in the second embodiment. Alternatively, the model management entity MNE may transmit the predetermined message including the LCM operation information (the NAS message when the model management entity MNE is the AMF 300) (FIG. 23), instead of the gNB 200 transmitting the RRC message to the UE 100.

### Other Operation Example 2 According to Third Embodiment

In the third embodiment, the UE 100 may request the gNB 200 to transmit the LCM operation information or confirm whether or not the LCM operation information has been transmitted, as in the second embodiment. Alternatively, the UE 100 may transmit the request and the confirmation to the model stock entity MSE. In this case, the UE 100 may transmit a message including the request or the confirmation (or the NAS message when the model stock entity MSE is the AMF 300) to perform the request or the confirmation.

### Other Operation Example 3 According to Third Embodiment

In the third embodiment, the model transmission entity MTE may also be a core network device. The core network device transmits the message including the model (step S702) and transmits the predetermined message including the LCM operation information (step S703). When the UE 100 executes the LCM-related operation for the model, the UE 100 transmits the message including the LCM operation execution information to the core network device (step S709). Other Operation Example 4 According to Third Embodiment

In the third embodiment, the model transmission entity MTE may also be an OTT server device. The OTT server device transmits the message including the model to the UE 100 (step S702) and transmits the message including the LCM operation information to the UE 100 (step S703). When the UE 100 has executed the LCM-related operation for the model, the UE 100 transmits a message including the LCM operation execution information to the OTT server device (step S709).

### Fourth Embodiment

Next, a fourth embodiment will be described. In the fourth embodiment, differences from the first to third embodiments will be mainly described.

In the third embodiment, an example in which, even when the execution condition is satisfied, the UE 100 continues to perform model inference without performing the LCM-related operation on the model, the UE 100 transmits the LCM operation permission information and then executes the operation for the model has been described. In the fourth embodiment, an example in which, if the UE 100 continues to perform the model inference without executing the operation for the model even when the execution condition is satisfied, the operation is automatically executed for the model without transmitting the LCM operation permission information will be described.

Specifically, first, the model reception entity (for example, the UE 100) receives the LCM operation disable information and the LCM operation condition information. Second, when the model reception entity has executed model inference using the AI/ML model regardless of the execution condition being satisfied, the model reception entity executes the LCM-related operation on the AI/ML model.

Accordingly, for example, since the UE 100 can execute the operation for the model based on the LCM operation information received from the network side (for example, the gNB 200), it is possible to execute the operation for the model in response to an instruction from the network side. Also, in the fourth embodiment, even the UE 100 with a specification that processing cannot be performed in accordance with the LCM operation information can execute the operation for the model, as in the third embodiment. Therefore, the UE 100 can appropriately execute the operation for the model.

In the fourth embodiment, there are two cases in which the LCM-related operation is executed for the model: a first case in which the model itself executes the operation, and a second case in which the operation is performed on model data linked to the model.

In the first case, for example, the controller 130 may compare the inference result data (and/or inference data) from the model inferrer A3 with the execution condition, and perform the LCM-related operation on the model when the execution condition is satisfied, as in the third embodiment. Alternatively, the controller 130 may execute the operation for the model when the model inferrer A3 outputs the error result instead of outputting the inference result data. Alternatively, the AI/ML model may perform the operation on its own model based on the inference result data from the model inferrer A3 and the LCM operation information, according to the same determination as the controller 130.

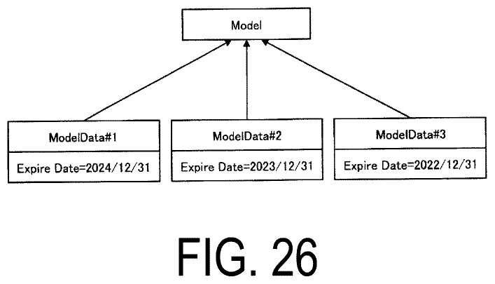

FIG. 26 is a diagram illustrating the second case. FIG. 26 shows an example of a relationship between the model and the model data according to the second embodiment. The model illustrated in FIG. 26 performs model training or performs model inference using any one of model data #1 to #3. Each of model data #1 to #3 has an expiration date. The expiration date may be included in the execution condition. In other words, the LCM operation information may include an execution condition that “model data #1 can be subjected to the LCM-related operation after Jan. 1, 2025” (indicating “being available until Dec. 31, 2024” as the expiration date), “model data #2 can be subjected to the LCM-related operation after Jan. 1, 2024” (indicating “being available until Dec. 31, 2023” as the expiration date), and “model data #3 can be subjected to the LCM-related operation after Jan. 1, 2023” (indicating “being available until Dec. 31, 2022” as the expiration date).

In this case, when the UE 100 receives the execution condition from the gNB 200, but the model illustrated in FIG. 26 performs the model inference using model data #3, the controller 130 causes the LCM-related operation (any one of selection, activation, deactivation, switching, fallback (using model data #3 in a non-AI/ML model), update, or transmission) to be performed on model data #3 stored in a memory of the UE 100 from a current date and time.

### Operation Example According to Fourth Embodiment

Next, an operation example according to the fourth embodiment will be described.

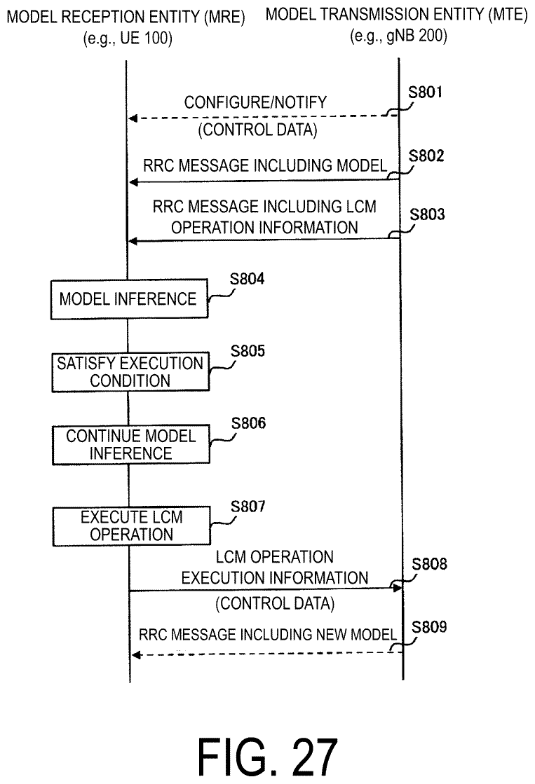

FIG. 27 is a diagram illustrating an operation example according to the fourth embodiment. The example illustrated in FIG. 27 illustrates an example in which the model transmission entity MTE is the gNB 200 and the model reception entity MRE is the UE 100, as in the third embodiment.

Steps S801 to S806 are the same as steps S701 to S706 (FIG. 25) of the third embodiment.

In step S807, the UE 100 executes the LCM-related operation for the model. The LCM operation information may include information on which operation (any one of selection, activation, deactivation, switching, fallback, update, or transmission) the UE 100 is to perform. As described above, when the inference result data of the model inferrer A3 satisfies the execution conditions, the model may perform the operation on its own model. The controller 130 may also execute the operation for the model. Alternatively, the controller 130 may perform the operation (any one of selection, activation, deactivation, switching, fallback, update, or transmission) on model data that satisfies the execution condition.

In step S808, the UE 100 transmits the LCM operation execution information to the gNB 200.

In step S809, the UE 100 may receive a new model from the gNB 200 and perform the next model inference (or model training) using the new model.

### Other Operation Example 1 According to Fourth Embodiment

In the fourth embodiment, the model stock entity MSE may transmit the predetermined message including the LCM operation information (the NAS message when the model stock entity MSE is the AMF 300) (FIG. 22B), instead of the gNB 200 transmitting the RRC message including the LCM operation information to the UE 100 (step S803), as in the third embodiment. Alternatively, the model management entity MNE may transmit a predetermined message including the LCM operation information (the NAS message when the model management entity MNE is the AMF 300) (for example, a second message) (FIG. 23), instead of the gNB 200 transmitting the RRC message to the UE 100.

### Other Operation Example 2 According to Fourth Embodiment

In the fourth embodiment, the UE 100 may request the gNB 200 to transmit the LCM operation information or confirm whether or not the LCM operation information has been transmitted, as in the second embodiment. Alternatively, the UE 100 may transmit the request and the confirmation to the model stock entity MSE. In this case, the UE 100 may perform the request or the confirmation using the message including the request or the confirmation (the NAS message when the model stock entity MSE is the AMF 300).

### Other Operation Example 3 According to Fourth Embodiment

In the fourth embodiment, the model transmission entity MTE may also be a core network device. The core network device transmits the message including the model (step S802) and transmits the predetermined message including the LCM operation information (step S803). When the UE 100 executes the LCM-related operation for the model, the UE 100 transmits the message including the LCM operation execution information to the core network device (step S808).

### Other Operation Example 4 According to Fourth Embodiment

The model transmission entity MTE may also be an OTT server device. The OTT server device transmits the message including the model to the UE 100 (step S802) and transmits the message including the LCM operation information to the UE 100 (step S803). When the UE 100 executes the LCM-related operation for the model, the UE 100 transmits the message including the LCM operation execution information to the OTT server device (step S809).

### OTHER EMBODIMENTS

### Other Embodiment 1

In the first to fourth embodiments, any one of selection, activation, deactivation, switching, fallback, update, or transmission has been described as the LCM-related operation, but the LCM-related operation is not limited thereto. For example, the LCM-related operation may be any one of data collection, model training, model registration, model deployment, model configuration, model monitoring, or model inference operation. In this case, the LCM operation disable information indicates whether an operation of any one of data collection, model training, model deployment, model configuration, or model inference is disabled. Further, the execution condition is an execution condition for any one of data collection, model training, model deployment, model configuration, or model inference.

### Other Embodiment 2

In the first embodiment described above, there may be a plurality of models that satisfy the execution condition. In this case, the UE 100 may select any one of the plurality of models according to priority. The priority may be notified by the gNB 200 through broadcast signaling. The priority may be notified by the gNB 200 through dedicated signaling. The priority may be included in the control data and transmitted from the gNB 200. Similarly, in the second to fourth embodiments, the UE 100 can select any one of the plurality of models based on the priority.

### Other Embodiment 3

In the first to fourth embodiments described above, supervised learning has been mainly described, but the present invention is not limited thereto. For example, the first to fourth embodiments may be applied to unsupervised learning or reinforcement learning.

### Other Embodiment 4

A program (for example, an information processing program) that causes a computer to execute each process or function according to the above-described embodiments may be provided. Alternatively, a program (for example, a mobile communication program) that causes the mobile communication system 1 to execute each process or function according to the above-described embodiments may be provided. The program may be recorded on a computer-readable medium. Use of the computer-readable medium enables the program to be installed on a computer. Here, the computer-readable medium on which the program is recorded may be a non-transitory recording medium. The non-transitory recording medium is not particularly limited, and may be, for example, a recording medium such as a CD-ROM or a DVD-ROM. Such a recording medium may be a memory included in the UE 100 and the gNB 200.

The above-described operation flows are not limited to being implemented independently, and may be implemented by a combination of two or more operation flows. For example, some steps of one operation flow may be added to another operation flow or some steps of one operation flow may be replaced with some steps of another operation flow. In each flow, all steps may not be necessarily performed, and only some of the steps may be performed.

In the above-described embodiments and examples, an example in which the base station is an NR base station (gNB) has been described, but the base station may also be an LTE base station (cNB) or a 6G base station. The base station may be a relay node such as an Integrated Access and Backhaul (IAB) node. The base station may be a DU of the IAB node. The UE 100 may be a Mobile Termination (MT) of the IAB node.

In other words, the UE 100 may be a terminal function unit (a type of communication module) that allows the base station to control a relay that relays signals. Such terminal function unit is referred to as an MT. Examples of the MT include, a Network Controlled Repeater (NCR)-MT, a Reconfigurable Intelligent Surface (RIS)-MT, in addition to the IAB-MT.

Further, the term “network node” primarily refers to a base station, but may also refer to a core network device or a part (CU, DU, or RU) of the base station. The network node may include a combination of at least a part of the apparatus of the core network and at least a part of the base station.

A program that causes a computer to execute each process performed by the UE 100 or the gNB 200 may be provided. The program may be recorded in a computer-readable medium. Use of the computer-readable medium enables the program to be installed on a computer. Here, the computer-readable medium on which the program is recorded may be a non-transitory recording medium. The non-transitory recording medium is not particularly limited, but may be, for example, a recording medium such as a CD-ROM or a DVD-ROM. Further, a circuit that executes each process performed by UE 100 or gNB 200 may be integrated, and at least a portion of the UE 100 or the gNB 200 may be configured as a semiconductor integrated circuit (chipset or SoC: system on a chip).

Functions performed by the UE 100 or the gNB 200 (network node) may be implemented in circuitry or processing circuitry, including a general-purpose processor, an application-specific processor, an integrated circuit, an application specific integrated circuit (ASIC), a central processing unit (CPU), a circuit of the related art, and/or a combination thereof, which is programmed to perform the described functions. The processor may include transistors and other circuits and may be considered a circuitry or a processing circuitry. The processor may be a programmed processor that executes a program stored in the memory. As used herein, a circuitry, a unit, means are hardware programmed to achieve, or hardware performing, the described functions. The hardware may be any hardware disclosed herein or any hardware programmed to achieve or known to perform the described functions. When the hardware is a processor that is considered to be a type of circuitry, the circuitry, means, or a unit is a combination of hardware and software used to configure the hardware and/or the processor.

The descriptions “based on” and “depending on/in response to” used in this disclosure do not mean “based only on” or “only in response to,” unless otherwise specified. The description “based on” means both “based only on” and “based at least partially on.” Similarly, the phrase “depending on” means both “only depending on” and “at least partially depending on”. The terms “include,” “comprise,” and variations thereof do not mean including only the listed items, but may mean including only the listed items or may include additional items in addition to the listed items. Also, the term “or” used in this disclosure is not intended to mean an exclusive OR. Any references to elements using designations such as “first” and “second” as used in the present disclosure do not generally limit the quantity or order of those elements. These designations may be used herein as a convenient method of distinguishing between two or more elements. Thus, a reference to first and second elements does not mean that only two elements may be employed there or that the first element needs to precede the second element in some manner. For example, when the English articles such as “a”, “an”, and “the” are added in the present disclosure through translation, these articles include the plural unless clearly indicated otherwise in context.

Although the embodiments have been described in detail above with reference to the drawings, specific configurations are not limited to those described above, and various design changes and the like can be made without departing from the gist. Further, it is also possible to combine the various embodiments, operation examples, or processes when there is no contradiction.

### Supplements

### Supplement 1

A communication control method in a mobile communication system, the communication control method including:
transmitting, by a model transmission entity to a model reception entity, life cycle management (LCM) operation disable information indicating whether a life cycle management (LCM)-related operation is disabled for an artificial intelligence (AI)/machine learning (ML) model and/or LCM operation condition information indicating an execution condition for the life cycle management (LCM)-related operation for the AI/ML model,
wherein the life cycle management (LCM)-related operation is any one of selection of the AI/ML model, activation of the AI/ML model, deactivation of the AI/ML model, switching of the AI/ML model, fallback from the AI/ML model to a non-AI/ML model, update of the AI/ML model, or transfer of the AI/ML model.

### Supplement 2

The communication control method according to supplement 1, wherein the transmitting includes transmitting, by the model transmission entity, the AI/ML model including the LCM operation disable information and/or the LCM operation condition information to the model reception entity.

### Supplement 3

The communication control method according to supplement 1 or 2, wherein the LCM operation disable information and/or the LCM operation condition information:
is included in file data including the AI/ML model;
is added to a model ID configured to identify the AI/ML model; or is included in meta information of the AI/ML model.

### Supplement 4

The communication control method according to any one of supplements 1 to 3, wherein the transmitting includes:
transmitting, by the model transmission entity, the AI/ML model to the model reception entity; and
transmitting, by the model transmission entity, a message including the LCM operation disable information and/or the LCM operation condition information to the model reception entity.

### Supplement 5

The communication control method according to any one of supplements 1 to 4, further including: transmitting, by a model stock entity configured to stock the AI/ML model, the message to the model reception entity instead of transmitting the message.

### Supplement 6

The communication control method according to any one of supplements 1 to 5, further including the steps of:
transmitting, by the model transmission entity, a first message including the LCM operation disable information and/or the LCM operation condition information to a model management entity managing the AI/ML model instead of transmitting the message; and
transmitting, by the model management entity, a second message including the LCM operation disable information and/or the LCM operation condition information to the model reception entity.

### Supplement 7

The communication control method according to any one of supplements 1 to 6, further including:
transmitting, by the model reception entity, request information configured to request transmission of the LCM operation disable information and/or the LCM operation condition information to the model transmission entity,
wherein the transmitting of the message includes transmitting, by the model transmission entity, the message to the model reception entity in response to receiving the request information.

### Supplement 8

The communication control method according to any one of supplements 1 to 7, further including:
transmitting, by the model reception entity, request information configured to request transmission of the LCM operation disable information and/or the LCM operation condition information to the model stock entity,
wherein the transmitting of the message includes transmitting, by the model stock entity, the message to the model reception entity in response to receiving the request information.

### Supplement 9

The communication control method according to any one of supplements 1 to 8, further including the steps of:
executing, by the model reception entity, the operation for the AI/ML model based on the LCM operation disable information and/or the LCM operation condition information; and
transmitting, by the model reception entity to the model transmission entity, LCM operation execution information indicating that the operation has been executed for the AI/ML model.

### Supplement 10

The communication control method according to any one of supplements 1 to 9, further including the steps of:
receiving, by the model reception entity, the LCM operation disable information and the LCM operation condition information; and
transmitting LCM operation permission information indicating whether execution of the operation for the AI/ML model is permitted together with or instead of inference result data to the model transmission entity when the model reception entity executes model inference using the AI/ML model without executing the operation for the AI/ML model regardless of the execution condition being satisfied.

### Supplement 11

The communication control method according to any one of supplements 1 to 10, further including:
executing, by the model reception entity, the operation for the AI/ML model after transmitting the LCM operation permission information.

### Supplement 12

The communication control method according to any one of supplements 1 to 11, further including the steps of:
receiving, by the model reception entity, the LCM operation disable information and the LCM operation condition information; and
executing, by the model reception entity, the operation on the AI/ML model when the model reception entity executes model inference using the AI/ML model without executing the operation on the AI/ML model regardless of the execution condition being satisfied.

### Supplement 13

The communication control method according to any one of supplements 1 to 12, wherein the model transmission entity is one of a base station, a core network device, or an OTT server device, and
the model reception entity is a user equipment.

### REFERENCE SIGNS

1: Mobile communication system
20: 5GC (CN)
100: UE
110: Receiver
120: Transmitter
130: Controller
200: gNB
210: Transmitter
220: Receiver
230: Controller
A1: Data collector
A2: Model trainer
A3: Model inferrer
A4: Data processor
TE: Transmission entity
RE: Reception entity
MTE: Model transmission entity
MRE: Model reception entity
MSE: Model stock entity
MNE: Model management entity

1. A communication control method in a mobile communication system, the communication control method comprising:
transmitting, by a model transmission entity to a model reception entity, life cycle management (LCM) operation disable information indicating whether a life cycle management (LCM)-related operation is disabled for an artificial intelligence (AI)/machine learning (ML) model and/or LCM operation condition information indicating an execution condition for the life cycle management (LCM)-related operation for the AI/ML model,
wherein the life cycle management (LCM)-related operation is any one of selection of the AI/ML model, activation of the AI/ML model, deactivation of the AI/ML model, switching of the AI/ML model, fallback from the AI/ML model to a non-AI/ML model, update of the AI/ML model, or transfer of the AI/ML model.

2. The communication control method according to claim 1, wherein the transmitting comprises transmitting, by the model transmission entity, the AI/ML model comprising the LCM operation disable information and/or the LCM operation condition information to the model reception entity.

3. The communication control method according to claim 2, wherein the LCM operation disable information and/or the LCM operation condition information:
is contained in file data comprising the AI/ML model;
is added to a model ID configured to identify the AI/ML model; or
is contained in meta information of the AI/ML model.

4. The communication control method according to claim 1, wherein the transmitting comprises:
transmitting, by the model transmission entity, the AI/ML model to the model reception entity; and
transmitting, by the model transmission entity, a message comprising the LCM operation disable information and/or the LCM operation condition information to the model reception entity.

5. The communication control method according to claim 4, further comprising: transmitting, by a model stock entity configured to stock the AI/ML model, the message to the model reception entity instead of transmitting the message.

6. The communication control method according to claim 4, further comprising:
transmitting, by the model transmission entity, a first message comprising the LCM operation disable information and/or the LCM operation condition information to a model management entity managing the AI/ML model instead of transmitting the message; and
transmitting, by the model management entity, a second message comprising the LCM operation disable information and/or the LCM operation condition information to the model reception entity.

7. The communication control method according to claim 4, further comprising:
transmitting, by the model reception entity, request information configured to request transmission of the LCM operation disable information and/or the LCM operation condition information to the model transmission entity,
wherein the transmitting of the message comprises transmitting, by the model transmission entity, the message to the model reception entity in response to receiving the request information.

8. The communication control method according to claim 5, further comprising:
transmitting, by the model reception entity, request information configured to request transmission of the LCM operation disable information and/or the LCM operation condition information to the model stock entity,
wherein the transmitting of the message comprises transmitting, by the model stock entity, the message to the model reception entity in response to receiving the request information.

9. The communication control method according to claim 1, further comprising:
executing, by the model reception entity, the operation for the AI/ML model based on the LCM operation disable information and/or the LCM operation condition information; and
transmitting, by the model reception entity to the model transmission entity, LCM operation execution information indicating that the operation has been executed for the AI/ML model.

10. The communication control method according to claim 1, further comprising:
receiving, by the model reception entity, the LCM operation disable information and the LCM operation condition information; and
transmitting LCM operation permission information indicating whether execution of the operation for the AI/ML model is permitted together with or instead of inference result data to the model transmission entity when the model reception entity executes model inference using the AI/ML model without executing the operation for the AI/ML model regardless of the execution condition being satisfied.

11. The communication control method according to claim 10, further comprising:
executing, by the model reception entity, the operation for the AIML model after transmitting the LCM operation permission information.

12. The communication control method according to claim 1, further comprising:
receiving, by the model reception entity, the LCM operation disable information and the LCM operation condition information; and
executing, by the model reception entity, the operation on the AI/ML model when the model reception entity executes model inference using the AI/ML model without executing the operation on the AI/ML model regardless of the execution condition being satisfied.

13. The communication control method according to claim 1, wherein
the model transmission entity is one of a base station, a core network device, or an OTT server device, and
the model reception entity is a user equipment.

14. A model transmission entity, comprising:
a transmitter configured to transmit, to a model reception entity, life cycle management (LCM) operation disable information indicating whether a life cycle management (LCM)-related operation is disabled for an artificial intelligence (AI)/machine learning (ML) model and/or LCM operation condition information indicating an execution condition for the life cycle management (LCM)-related operation for the AI/ML model,
wherein the life cycle management (LCM)-related operation is any one of selection of the AI/ML model, activation of the AI/ML model, deactivation of the AI/ML model, switching of the AI/ML model, fallback from the AI/ML model to a non-AI/ML model, update of the AI/ML model, or transfer of the AI/ML model.
